(19) United States
(12) Patent Application Publication
(10) Pub. No.: US 2018/0107758 A1
(43) Pub. Date: Apr. 19, 2018

(54) APPARATUS AND METHOD FOR CHANGING WEBPAGE OUTPUT SCHEME

(71) Applicant: Young Sik HA, Seoul (KR)

(72) Inventors: Young Sik HA, Seoul (KR); Su Min HA, Seoul (KR)

(73) Assignee: Young Sik HA, Seoul (KR)

(21) Appl. No.: 15/567,317

(22) PCT Filed: Dec. 2, 2015
(86) PCT No.: PCT/KR2015/013032

§ 371 Date: Oct. 17, 2017

(30) Foreign Application Priority Data
Apr. 22, 2015 (KR) 10-2015-0056825

(51) Int. Cl. G06F 17/30; G06F 3/0484

(52) U.S. Cl. CPC G06F 17/30905; G06F 3/0484

(57) ABSTRACT

An apparatus for changing a webpage output scheme includes a size change detector detecting a size change of an output space outputting a webpage, a pattern determiner, when the size change is detected, determining whether the size change corresponds to a previously stored size change pattern, an output scheme changer, when the size change corresponds to the size change pattern, changing an output scheme to rearrange a position of a constituent item constituting the webpage based on a changed size of the output space, and a change output device outputting the webpage through a changed output space according to a changed output scheme.

### TECHNICAL FIELD

The present inventive concept relates to an apparatus and method of changing a webpage output scheme, and more particularly, to an apparatus and method for outputting a webpage in a space for outputting a webpage having a size that is changed as the size of the space is changed according to a user's input.

### BACKGROUND ART

A webpage output through a window of a web browser is output according to an output scheme that may be changed by a user's input. For example, when a user wants to see a webpage large and wide, the user may directly increase the size of the web browser window by using an input device such as a mouse. When the user wants to see the content of the webpage big while maintaining the size of the web browser window for other tasks, the user may directly change an output ratio of the webpage.

In the case of directly increasing the size of the web browser window, although the user may see the webpage big and wide, an insufficient space problem occurs due to the increased size of the web browser window, and thus a window of a program that is opened for other work may not be output properly, which is inefficient in performing multitasking.

In addition, when directly changing only the output ratio of the webpage while maintaining the size of the web browser, the user may see the content of the webpage big, but due to a limited size of the web browser window, a lot of scroll operations to see the whole content output by the webpage may be inconveniently performed.

As monitor technologies have developed, the size of a screen of a terminal that outputs the content has gradually increased. Accordingly, even when the webpage is output by being reduced to the size of a web browser window having a relatively small size, since readability may be sufficiently secured, the user may have no difficulty recognizing the content of the webpage. Thus, there is demand for technologies that allow the user to view the content of the webpage at a glance without performing separate scroll operations on a web browser window having a size that is sufficient to perform multitasking without difficulty.

### DETAILED DESCRIPTION OF THE INVENTIVE CONCEPT

### Technical Problem

The present inventive concept provides an apparatus and method for changing a webpage output scheme, in which a change in the size of a web browser window by a user is detected and thus the webpage output scheme is changed, thereby enhancing user convenience in surfing the web, a computer-readable recording medium having recorded thereon a program for executing the method of changing a webpage output scheme, and a webpage multi-output method implemented by the webpage output scheme changing method.

### Technical Solution

According to one aspect of the present inventive concept, there is provided an apparatus for changing a webpage output scheme, which includes a size change detector detecting a size change of an output space outputting a webpage, a pattern determiner, when the size change is detected, determining whether the size change corresponds to a previously stored size change pattern, an output scheme changer, when the size change corresponds to the size change pattern, changing an output scheme to rearrange a position of a constituent item constituting the webpage based on a changed size of the output space, and a change output device outputting the webpage through a changed output space according to a changed output scheme.

According to another aspect of the present inventive concept, there is provided a method of changing a webpage output scheme, which includes a size change detection operation of sensing a size change of an output space outputting a webpage, a pattern determination operation of, when the size change is detected, determining whether the size change corresponds to a previously stored size change pattern, an output scheme change operation of, when the size change corresponds to the size change pattern, changing an output scheme to rearrange a position of a constituent item constituting the webpage based on a changed size of the output space, and a change output operation of outputting the webpage through a changed output space according to a changed output scheme.

### Advantageous Effects

According to the present inventive concept, since the user may view the content provided by a webpage at a glance without performing separate scroll operations by only adjusting the size of a web browser window, the user may conveniently surf the web while performing other work. Also, when generally surfing the web, the user may be provided with improved visual effects.

### DESCRIPTION OF THE DRAWINGS

FIG. 1 is a block diagram of an apparatus for changing a webpage output scheme according to an embodiment.

FIG. 2 is a flowchart showing, in a time-series manner, an operation of determining a new output scheme in an output scheme changer.

FIGS. 3A, 3B, and 3C schematically illustrate a process in which an output scheme is changed by the output scheme changer.

FIGS. 4A, 4B, and 4C schematically illustrate an example of a webpage output scheme changed according to a size change ratio.

FIGS. 5A, 5B, and 5C schematically illustrate another example of a webpage output scheme changed according to a size change ratio.

FIGS. 6A, 6B, 6C, and 6D schematically illustrate that a plurality of frames included in a changed output space are distinguished by Inequality 1.

FIGS. 7A and 7B schematically illustrate another embodiment of a webpage output scheme changed by the output scheme changer.

FIGS. 8A and 8B schematically illustrate an example of a web browser window for explaining a space remover and a space expander.

FIG. 9A schematically illustrates an example of a scroll button displayed in an individual output space.

FIG. 9B schematically illustrates another example of the scroll button displayed in the individual output space.

FIG. 10 schematically illustrates an effective change point that may be implemented by a size change detector.

FIG. 11 schematically illustrates a combined webpage having a plurality of output areas according to an embodiment.

FIG. 12 schematically illustrates a result of removing one output area from a web browser window outputting a combined webpage having a plurality of output areas.

FIG. 13 schematically illustrates a result of removing one output area from a web browser window outputting a combined webpage having a plurality of output areas according to an embodiment different from FIG. 12.

FIG. 14 is a flowchart showing a process of removing a particular output area from a web browser window outputting a combined webpage having a plurality of output areas.

FIG. 15 is a flowchart showing a method of changing a webpage output scheme according to another embodiment.

### BEST MODE

According to an aspect of the present inventive concept, there is provided an apparatus for changing a webpage output scheme, which includes a size change detector detecting a size change of an output space outputting a webpage, a pattern determiner, when the size change is detected, determining whether the size change corresponds to a previously stored size change pattern, an output scheme changer, when the size change corresponds to the size change pattern, changing an output scheme to rearrange a position of a constituent item constituting the webpage based on a changed size of the output space, and a change output device outputting the webpage through a changed output space according to a changed output scheme.

The output scheme changer may calculate a size change ratio by comparing the changed size of the output space with the size of the output space before a change, when the size change corresponds to the size change pattern, and may change the output scheme of the webpage that is output through the changed output space according to the size change ratio.

The size change may be a reduction in a vertical length, and when the size change corresponds to the size change pattern, the output scheme changer may reduce horizontal and vertical lengths of the constituent item based on the changed size of the output space and the size change ratio, and may change the output scheme to rearrange a position of a reduced constituent item.

The size change may be a reduction in a vertical length, the output scheme changer may calculate an expanded output space by additionally expanding the horizontal length of the changed output space according to the size change ratio, and the change output device may output the webpage through the expanded output space according to the changed output scheme.

The change output device may divide the changed output space into at least two individual output spaces, and each constituent item rearranged by the output scheme changed by the output scheme changer may be output through the individual output space.

The individual output space may include a space removal button that receives a user's selection, and the change output device may include a space remover removing the individual output space including the space removal button, when the space removal button is selected, and a space expander expanding an individual output space adjacent to the removed individual output space as large as a space calculated due to the removed individual output space.

The size change pattern may include a reduction in the horizontal length or vertical length over a certain ratio or more among the horizontal length or vertical length of the output space.

When the size change of the output space is detected, the size change detector may display in the output space an effective change point to change the output scheme of the webpage that is output through the output space.

The output space may be one of a plurality of output areas included in a combined webpage, and an independent webpage may be output through each of the plurality of output areas, and the size of the output area may be changeable.

According to another aspect of the present inventive concept, there is provided a method of changing a webpage output scheme, which includes a size change detection operation of sensing a size change of an output space outputting a webpage, a pattern determination operation of, when the size change is detected, determining whether the size change corresponds to a previously stored size change pattern, an output scheme change operation of, when the size change corresponds to the size change pattern, changing an output scheme to rearrange a position of a constituent item constituting the webpage based on a changed size of the output space, and a change output operation of outputting the webpage through a changed output space according to a changed output scheme.

In the output scheme change operation, when the size change corresponds to the size change pattern, a size change ratio may be calculated by comparing the changed size of the output space with the size of the output space before a change, and the output scheme of the webpage that is output through the changed output space may be changed according to the size change ratio.

The size change may be a reduction in a vertical length, and in the output scheme change operation, when the size change corresponds to the size change pattern, horizontal and vertical lengths of the constituent item may be reduced based on the changed size of the output space and the size change ratio, and the output scheme to rearrange a position of a reduced constituent item may be changed.

The size change may be a reduction in a vertical length, in the output scheme change operation, an expanded output space by additionally expanding the horizontal length of the changed output space according to the size change ratio may be calculated, and in the change output operation, the webpage may be output through the expanded output space according to the changed output scheme.

In the change output operation, the changed output space may be divided into at least two individual output spaces, and each constituent item rearranged by the output scheme changed in the output scheme change operation may be output through the individual output space.

The individual output space may include a space removal button that receives a user's selection, and the change output operation may include a space removal operation of removing the individual output space including the space removal button, when the space removal button is selected; and a space expanding operation of expanding an individual output space adjacent to the removed individual output space as large as a space calculated due to the removed individual output space.

The size change pattern may include a reduction in the horizontal length or vertical length over a certain ratio or more among the horizontal length or vertical length of the output space.

In the size change sensing operation, when the size change of the output space is detected, an effective change point to change the output scheme of the webpage that is output through the output space may be displayed in the output space.

The output space may be one of a plurality of output areas included in a combined webpage, and an independent webpage may be output through each of the plurality of output areas, and the size of the output area may be changeable.

According to another aspect of the present inventive concept, there is provided a non-transitory computer readable recording medium having recorded thereon a program, which when executed by a computer, performs the method of changing a webpage output scheme, which includes a size change detection operation of sensing a size change of an output space outputting a webpage, a pattern determination operation of, when the size change is detected, determining whether the size change corresponds to a previously stored size change pattern, an output scheme change operation of, when the size change corresponds to the size change pattern, changing an output scheme to rearrange a position of a constituent item constituting the webpage based on a changed size of the output space, and a change output operation of outputting the webpage through a changed output space according to a changed output scheme.

### Mode of the Inventive Concept

As the inventive concept allows for various changes and numerous embodiments, embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope of the present inventive concept are encompassed in the present inventive concept.

Hereinafter, the present inventive concept will be described in detail by explaining embodiments of the inventive concept with reference to the attached drawings. Like reference numerals in the drawings denote like elements, and thus their description will be omitted.

Terms such as “first” and “second” are used herein merely to describe a variety of constituent elements, but the constituent elements are not limited by the terms. Such terms are used only for the purpose of distinguishing one constituent element from another constituent element.

In the following embodiments, the expression of singularity in the present specification includes the expression of plurality unless clearly specified otherwise in context.

In the following embodiments, it will be further understood that the terms “comprises” and/or “comprising” used herein specify the presence of stated features or components, but do not preclude the presence or addition of one or more other features or components.

When a certain embodiment may be implemented differently, a specific process order may be performed differently from the described order. For example, two consecutively described processes may be performed substantially at the same time or performed in an order opposite to the described order.

A web document described below may signify a document in which the content output by a webpage when a user accesses the webpage through a web browser is written in various languages according to preset forms or grammar. The language used to create a web document may include not only general programming languages such as C and Java, but also various markup languages such as HyperText Markup Language (HTML) and Extensible Markup Language (XML).

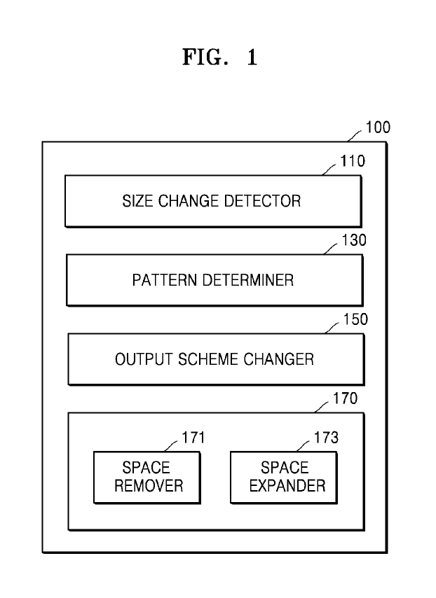

FIG. 1 is a block diagram of an apparatus for changing a webpage output scheme according to an embodiment.

Referring to FIG. 1, an apparatus 100 for changing a webpage output scheme according to an embodiment may include a size change detector 110, a pattern determiner 130, an output scheme changer 150, and a change output device 170.

The size change detector 110 detects a change in the size of an output space outputting a webpage. Assuming that a user uses the Internet through a terminal connected to a wired/wireless network, the webpage may be the content output through a web browser window when the user inputs an address of a particular site to the web browser window. The webpage characteristically includes different content according to a site address input by the user.

A recent webpage includes a huge amount of content. Since the size of a user's display device displaying a webpage is limited, the webpage is generally created to be displayed long in a vertical direction compared to a horizontal direction. Accordingly, the user may access content of the webpage that is not initially output through the web browser window by applying an input to a scroll button through an input device such as a mouse in the web browser window.

In the present specification, an output space may indicate a part output through the web browser window according to a user's current settings such as the position of the scroll button, from the entire webpage. The webpage output to the output space may be the whole content of the webpage that may be output corresponding to a webpage address, or may be a part of the content of the webpage.

The size change of the output space outputting a webpage is possible by the user's input. The user may change the size of a web browser window displaying the webpage. The output space of a webpage may be increased or decreased according to the changed size of the web browser window. For example, when the user reduces the horizontal length of a web browser window, the size change detector 110 may detect that the output space of a webpage is horizontally reduced.

When detecting the size change of the output space outputting a webpage, the size change detector 110 may transfer information about the size change to the pattern determiner 130.

The information about the size change may signify information about how large the output space outputting a webpage is expanded or reduced in which direction by the user's input.

In some embodiments, when the size change of the output space is detected, the size change detector 110 may display in the output space an effective change point to change a webpage output scheme output through the output space.

The effective change point may be a minimum change point where a webpage is output by a webpage output scheme that is changed by the apparatus for changing a webpage output scheme according to the present embodiment.

In the present inventive concept, the output scheme means how to output a webpage by adjusting the positions or ratios of constituent items constituting the webpage to fit to a screen of a user's terminal. Furthermore, in the present inventive concept, the change of an output scheme may signify changing the size of an item constituting a webpage or rearranging the item whose size has been changed.

The webpage may include a plurality of items, and the position of an item constituting the webpage is preset on a script to output the webpage. The present inventive concept is devised to detect a user's input to change the size of an output space of a webpage and change a webpage output scheme so that the webpage may be conveniently viewed by the user. The change of the output scheme is described below in the description about the output scheme changer 150.

When the size of a web browser window implemented by the present inventive concept is changed by the user's input, the size of an output space outputting a webpage is changed as well. However, if the user did not intend to change the size of the web browser window, or when a degree of the size change is negligible even if the user intended to change the size of the web browser window, it is reasonable not to change the webpage output scheme in spite of the user's input. Thus, the size change detector 110 may display in the output space the effective change point where the output scheme is changed according to the present inventive concept, thereby guiding the user to further change the size of the output space.

The effective change point stored in the size change detector 110 may be set in units of pixels or may be set to be a ratio to the size of a current web browser window. For example, when the effective change point is set to be 30 pixels, in order to change the webpage output scheme, the user needs to expand or reduce at least one of a horizontal length or a vertical length of a web browser window by 30 pixels or more. In another example, when the effective change point is set to be 20% as a ratio to the size of a current web browser window, in order to change the webpage output scheme, the user needs to expand at least one of the horizontal length or the vertical length of the web browser window by 120% or more or reduce the same by 80% or less.

The size change detector 110 stores information about an effective change point corresponding to the minimum change point and displays the effective change point in the output space whenever the user tries to change the size of a web browser window. Accordingly, the user may visually check a degree of the size change of the output space needed to change the webpage output scheme.

In some embodiments, the effective change point may be defined to be not only the minimum change point to output a webpage by changing the webpage output scheme, but also a recommended change point where the webpage output scheme is most ideally changed to output the webpage.

For example, when the size change detector 110 receives a user's input and detects that the vertical length of the output space of a webpage is reduced, the size change detector 110 may display portions corresponding to ½, ⅓, and ⅕ points of an overall vertical length of the output space, thereby guiding the user to change the size of the output space of a webpage to any one of the above points. In the above example, the ½, ⅓, and ⅕ points are exemplary and the output space of a webpage may be reduced not only in the vertical length of the output space but also in the horizontal length thereof.

Furthermore, the point where the effective change point is displayed may be a preset particular point. For example, the effective change point may be fixedly displayed at a location where the 100th pixel from the top of the output space is located. In such a method, regardless of the total size of the output space, the point where the effective change point is displayed is located at a location where the 100th pixel from the top of the output space is located.

Since the size change detector 110 storing the information about the effective change point corresponding to the recommended change point displays the effective change point when detecting that the user tries to change the size of a web browser window, the user may easily change the size of the output space referring to the effective change point.

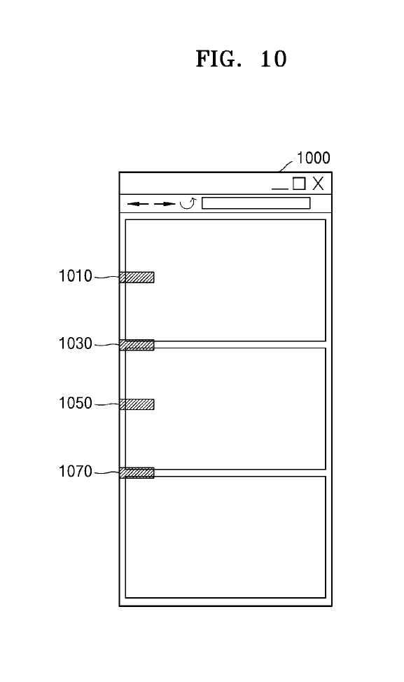

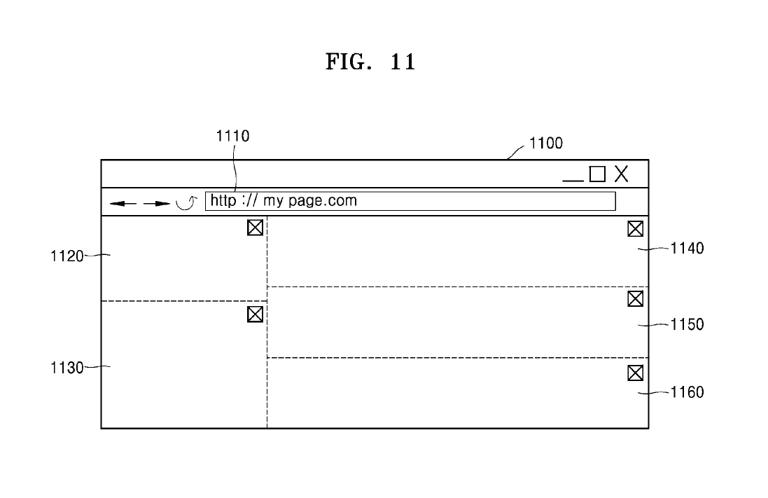

The effective change point implemented by the size change detector 110 is schematically shown in FIG. 10.

FIG. 10 schematically illustrates an effective change point that may be implemented by the size change detector 110.

Referring to FIG. 10, there are four effective change points including a point 1010 corresponding to ⅙ of the vertical length of the output space, a point 1030 corresponding to ⅓ of the vertical length of the output space, a point 1050 corresponding to ½ of the vertical length of the output space, and a point 1070 corresponding to ⅔ of the vertical length of the output space. Among the points, the points 1010, 1030, and 1050 are the effective change points as the recommended change points, whereas the point 1070 may have both features as the recommended change point and the minimum change point. In other words, referring to FIG. 10, as the user reduces the vertical length of the output space by at least ⅔, the webpage output scheme may be changed according to the present inventive concept.

In some embodiments, even when the size change detector 110 detects the size change of the output space, the user may set such that the detected information about the size change is not transferred to the pattern determiner 130. In other words, the user may change the webpage output scheme according to the present inventive concept only when the user desires so.

The pattern determiner 130 receives the information about the size change of the output space from the size change detector 110 and determines whether the size change corresponds to a previously stored size change pattern.

The size change pattern is information previously stored in the pattern determiner 130 to compare the information about the size change of the output space received from the size change detector 110. The size change pattern stored in the pattern determiner 130 may include at least one of a size change direction, a size change degree, and a size change type. The size change direction may be a horizontal direction or a vertical direction, the size change degree may be a fixed constant or ratio, and the size change type may be either expansion or reduction.

For example, when the size is changed in the horizontal direction and a size change pattern to perform an output scheme change process of the present inventive concept is set, the pattern determiner 130 receives the information about the size change of the output space in the horizontal direction from the size change detector 110, and may determine that the size change corresponds to the previously stored size change pattern, regardless of the degree or type of the size change of the output space. As described above, the pattern determiner 130 determines whether the size change corresponds to the previously stored size change pattern by analyzing the information about the size change of the output space to find out the direction, degree, and type of the size change of the output space, and comparing the found direction, degree, and type of the size change of the output space with the direction, degree, and type of the previously stored size change pattern, one by one.

At least one size change pattern is stored in the pattern determiner 130. The number of the size change patterns stored in the pattern determiner 130 may be increased or decreased by a user having a right to change the setting of the apparatus for changing a webpage output scheme according to the present inventive concept.

When the size of the output space of the web browser window is changed within a range previously stored in the size change pattern, the pattern determiner 130 may determine that the size change corresponds to the previously stored size change pattern. The size change pattern stored in the pattern determiner 130 may be set to have a sufficient allowable range to cope with user's various motions. After determining whether the size change by the user's input corresponds to the previously stored size change pattern, the pattern determiner 130 transfers a result of the determination to the output scheme changer 150.

When receiving a result of the determination from the pattern determiner 130 that the size change of the output space does not correspond to the previously stored size change pattern, the output scheme changer 150 does not change the output scheme.

In some embodiments, when determining that the size change of the output space does not correspond to the previously stored size change pattern, the pattern determiner 130 may not transfer the determination result to the output scheme changer 150 and may not change the output scheme.

In other words, while the pattern determiner 130 determines whether the size change of the output space corresponds to the previously stored size change pattern, one of the pattern determiner 130 and the output scheme changer 150 may determine not to change the webpage output scheme according to the determination result.

When the size change of the output space corresponds to the size change pattern, the output scheme changer 150 may change the output scheme to have the positions of constituent items constituting the webpage rearranged based on the changed size of the output space. In detail, according to a result of the determination by the pattern determiner 130, the output scheme changer 150 may change the webpage output scheme based on the size of the output space before the change by the user's input and the size of the output space after the change by the user's input.

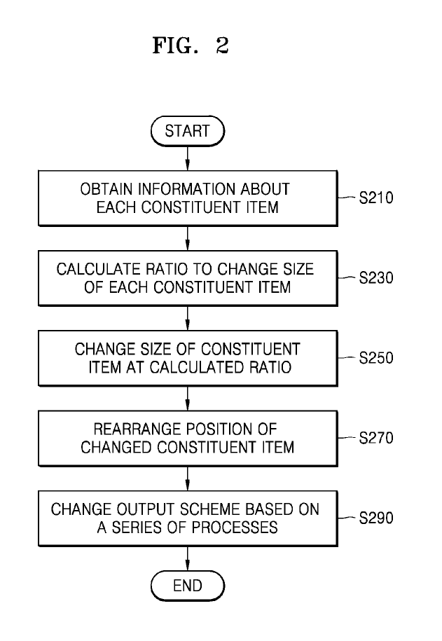

The output scheme changer 150 changes an existing output scheme to a new output scheme according to a process shown in the flowchart of FIG. 2.

FIG. 2 is a flowchart showing, in a time-series manner, an operation of determining a new output scheme in the output scheme changer 150.

First, the output scheme changer 150 may analyze a script written in a web document about a webpage, and obtain information about each item constituting the webpage (S210).

In detail, in Operation S210, the output scheme changer 150 may identify constituent items such as a banner, a motion picture, a still image, text, etc. output by being included in a webpage, from the script written in the web document, by opening the web document about the webpage that may be accessed by accessing a webpage address, and obtain information about each of the identified constituent items. The information about the constituent item may include information about a size such as a width or height of a constituent item.

After obtaining the information about each item constituting the webpage, the output scheme changer 150 determines a ratio to change the size of each constituent item based on the changed size of the output space (S230).

An item change ratio described below may denote a ratio by which the output scheme changer 150 changes the size of each constituent item.

As an example in which the output scheme changer 150 determines the item change ratio based on the changed size of the output space, the output scheme changer 150 analyzes at which ratio the size of the output space before the change is changed to the size of the output space after the change and then determines the item change ratio based on the determined ratio.

For example, when the vertical length of the output space is reduced to ⅓ by the user's input, the horizontal length and vertical length of each constituent item may be reduced to ⅓ of the original length to be output in a changed output space. The ⅓ is a size change ratio, which signifies a ratio between the size of output space before the change and the changed size of the output space. The horizontal length and vertical length of each constituent item may be reduced to a ratio different from ⅓.

As another example in which the output scheme changer 150 determines the item change ratio based on the changed size of the output space, when the size of the output space is changed, the output scheme changer 150 determines a value corresponding to the changed size of the output space to be an item change ratio. For example, the output scheme changer 150 may determine the item change ratio at which the horizontal length and vertical length of each constituent item are reduced by 10 pixels based on that the vertical length of the output space is reduced by 100 pixels or more. In the present embodiment, a value corresponding to the size change of the output space determined to be the item change ratio is previously stored in the output scheme changer 150.

As another example in which the output scheme changer 150 determines the item change ratio based on the changed size of the output space, the output scheme changer 150 may determine the item change ratio based on the changed size of the output space and the entire length of the webpage.

Inequality 1 shows an example used when the output scheme changer 150 determines the item change ratio based on the changed size of the output space and the entire length of the webpage.

$${c}^{2} \leq \frac{b}{a} \qquad [ Inequality 1 ]$$

Inequality 1 shows an example of a relation among the entire vertical length of the webpage, the changed vertical length of the output space, and the item change ratio when the vertical length of the output space of the webpage is reduced. In Inequality 1, “a” denotes the entire vertical length of the webpage, “b” denotes the changed vertical length of the output space, and “c” denotes the item change ratio. “c” is in the form of 1/n, where “n” is an integer greater than 1. Since “a” signifies the entire vertical length of the webpage that may be output according to the webpage address, “a” may be a value obtained by summing the vertical length of the webpage output in the output space before the change and the vertical length of the webpage that is not output in the output space before the change.

The output scheme changer 150 determines the item change ratio by selecting only the largest value from among values satisfying a correlation such as Inequality 1. For example, when there are a plurality of values “c” such as ⅓, ¼, and ⅕ satisfying Inequality 1, the output scheme changer 150 determines ⅓ to be the item change ratio.

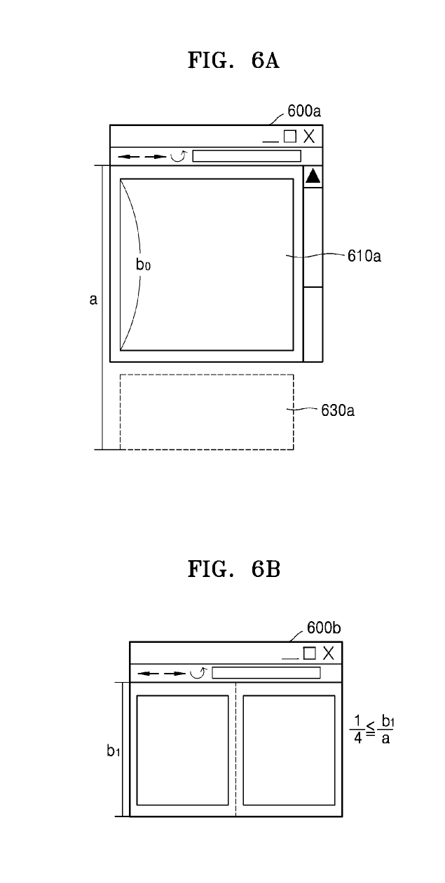

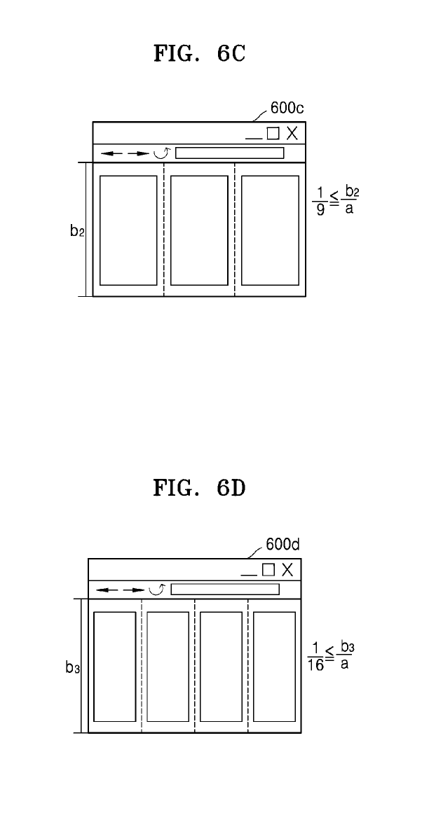

The output scheme changer 150 determines the item change ratio according to the correlation such as Inequality 1 in order to output the entire content included in the webpage to the output space, which is schematically described below with the description of FIG. 6.

The output scheme changer 150 determines the item change ratio to change the size of each constituent item based on the changed size of the output space, and then changes the size of each constituent item according to the determined item change ratio (S250).

In some embodiments, referring to Inequality 1, the output scheme changer 150 may determine the item change ratio to change the size of a constituent item constituting the webpage based on the entire vertical length of the webpage and the changed vertical length of the output space, and then change the size of each constituent item according to the determined item change ratio.

In Operation S250, the size of the constituent item signifies at least one of the horizontal length and the vertical length of the constituent item. In other words, the constituent item may be changed in the horizontal length only, in the vertical length only, or in both the horizontal length and the vertical length, according to the item change ratio. The direction in which the constituent item is changed may be preset by the output scheme changer 150 or may be set according to a value set by the user.

There is at least one constituent item constituting the webpage, and each constituent item is changed according to the item change ratio in the same method. In other words, when one of a plurality of constituent items constituting the webpage is changed in the horizontal length only according to the item change ratio, the others are changed in the horizontal length only according to the item change ratio.

In a simple example, when the size of the output space is increased by the user's input, the output scheme changer 150 may change the output scheme to expand the size of each constituent item based on the increased size of the output space. In the same principle, when the size of the output space is decreased by the user's input, the output scheme changer 150 may change the output scheme to reduce the size of each constituent item based on the decreased size of the output space.

In detail, the output scheme changer 150 may change the size of the constituent item by applying the item change ratio to a value about the size of the constituent item written in the web document about the webpage by a script. In other words, as values about the width and height of a constituent item in the web document about the webpage are directly corrected according to the item change ratio, the size of the constituent item may be changed.

When the size of the constituent item is changed, the output scheme changer 150 may rearrange the constituent items having changed sizes in the output space having a changed size (S270).

First, the output scheme changer 150 divides a changed output space into at least two frames based on the direction in which the size of the output space is changed and the item change ratio. Each frame may be defined to be a space included in the changed output space that outputs a constituent item having a changed size. As an example of calculating the number of frames included in the changed output space, the number of frames included in the changed output space may be a reciprocal of the item change ratio. Since the item change ratio is expressed in the form of 1/n, where “n” is an integer greater than 1, the number of frames included in the changed output space may be 2, 3, or 4. The frames in the output space may be implemented by a method of inserting a script to divide one output space into a plurality of frames in the web document about the webpage.

The output scheme changer 150 sequentially arranges the constituent items having changed sizes in the at least two frames. The output scheme changer 150 arranges a constituent item having a changed size in a frame located at the leftmost side in the changed output space. The present embodiment is suggested to allow an existing webpage output long in the vertical direction to be viewed long in the horizontal direction, the constituent items located at the top of the webpage may be arranged in the frame located at the leftmost side with their sizes changed.

When no more remaining space to arrange the constituent items therein is left as the constituent items having changed sizes are arranged in the frame located at the leftmost side, the output scheme changer 150 repeats arrangement of the constituent item having a changed size in a frame next to the frame located at the leftmost side, and thus all constituent items constituting the webpage may be output in the respective frames of the changed output space.

As an example in which the output scheme changer 150 determines that no remaining space is left in the frame, the output scheme changer 150 may calculate the vertical length of the webpage that may be output from the leftmost frame, and may determine that there is no remaining space left in the leftmost frame, based on a result of the calculation.

As another example in which the output scheme changer 150 determines that no remaining space is left in the frame, the output scheme changer 150 may receive information indicating that no constituent item may be arranged in the frame, and may determine that no remaining space is left in the leftmost frame, based on the received information. The output scheme changer 150 may determine that the remaining space to arrange the constituent item is insufficient in the frame, based on the information indicating that no constituent item may be arranged in a current frame, and may arrange the constituent item having a changed size in a next frame.

Alternatively, the output scheme changer 150 may determine that it is inappropriate to divide and arrange a constituent item that is a still image or a motion picture having a relatively large size, across two frames, and may arrange the constituent item in a next frame having a sufficient space.

Finally, the output scheme changer 150 may define a new output scheme based on the constituent item determined through the previous operations S210, S230, S250, and S270, a reduction ratio of the constituent item, and information needed to rearrange a reduced constituent item in the changed output space, and may change the existing output scheme to a newly defined output scheme (S290). In Operation S290, the output scheme changed by the output scheme changer 150 is transferred to the change output device 170 that is described below.

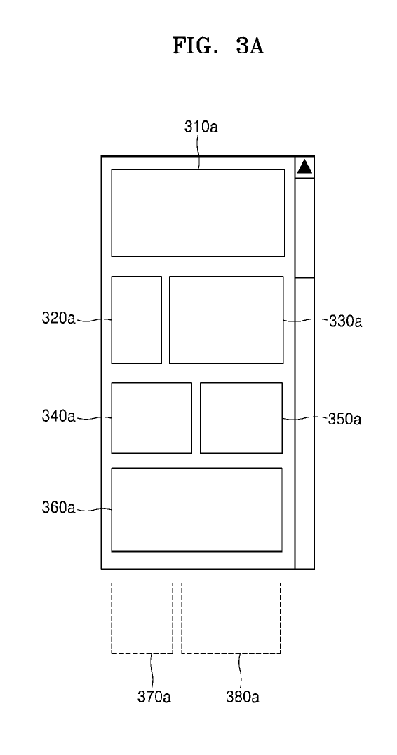

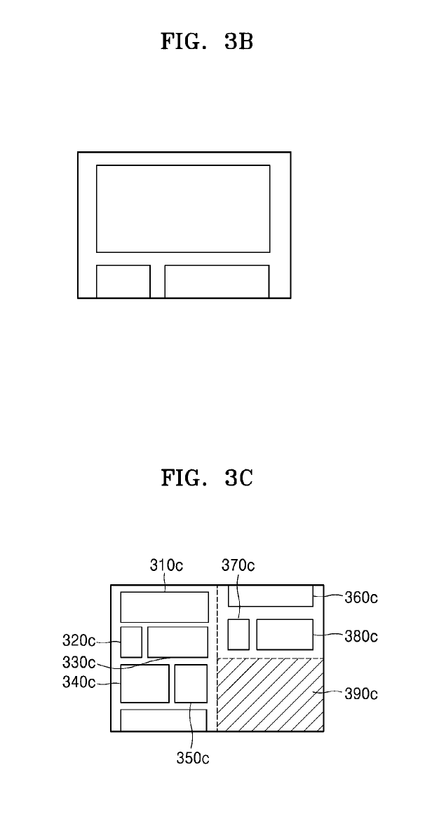

When a degree of changing the size of a web browser window by the user is not much or the length of the webpage corresponds to a specific length, space may be left after the constituent item having a changed size is arranged in each frame, which is schematically described below with the description of FIG. 3.

FIGS. 3A, 3B, and 3C schematically illustrate a process in which an output scheme is changed by the output scheme changer 150.

Referring to FIG. 3A, some constituent items of a webpage are output in an output space before the output scheme is changed, and the other constituent items may be output when the user presses the scroll button. The constituent items output in the output space may include first to sixth constituent items 310a, 320a, 330a, 340a, 350a, and 360a, and the other constituent items may include a seventh constituent item 370a and an eighth constituent item 380a.

Referring to FIG. 3A, the output scheme changer 150 may identify the constituent items 310a, 320a, 330a, 340a, 350a, and 360a output in the output space and the other constituent items 370a and 380a by comparing the vertical length of the output space with the entire vertical length of the webpage.

First, the output scheme changer 150 compares the vertical length of the output space formed by the size of a current web browser window with the entire vertical length of the webpage defined on a web document about the webpage.

Next, the output scheme changer 150 recognizes information about the position of each item constituting the webpage from the content of the web document about the webpage.

The output scheme changer 150 may identify a constituent item located at a position exceeding the vertical length of the output space in the entire vertical length of the webpage, among the respective constituent items constituting the webpage, and may recognize the identified constituent item to be the other constituent items to be output in the output space when the user presses the scroll button of the web browser window. In other words, since the seventh constituent item 370a and the eighth constituent item 380a described above are located at positions exceeding the vertical length of the output space in the entire vertical length of the webpage, when the user presses the scroll button, the seventh and eighth constituent items 370a and 380a may be output in the output space, and thus they may be classified as the other constituent item.

Each constituent item illustrated in FIG. 3A may denote a different content. For example, the first constituent item 310a may be a search word input section in which the user inputs a search word, the second constituent item 320a may be a login information input section in which the user inputs an ID and a password to perform a login process, and the third constituent item 330a may be a dynamic image banner for an online game advertisement. The horizontal length and the vertical length of each constituent item are defined in the web document about the webpage. Furthermore, a content presented by each constituent item may vary according to an object such as text, a website, a motion picture, or a still image designated in the web document about the webpage. FIG. 3B illustrates an example in which the vertical length of the output space of FIG. 3A is reduced by the user's input. Referring to FIG. 3B, it may be seen that, as the vertical length of the output space is reduced, the number of constituent items output through the output space of FIG. 3B is reduced. In other words, since FIG. 3B illustrates the output space when the present inventive concept is not implemented, the whole first constituent item 310a and upper parts of the second constituent item 320a and the third constituent item 330a only are output in the output space of FIG. 3B.

FIG. 3C illustrates an example in which, when the present inventive concept is implemented, the vertical length of the output space of FIG. 3A is reduced by the user's input.

In FIG. 3C, when the vertical length of the output space of FIG. 3A is reduced, the output scheme changer 150 obtains information about each item constituting the webpage by analyzing a script of the web document about the webpage output in the output space. In the process, the output scheme changer 150 may obtain information about the position and the size, such as a width or a height, of each of the first to eighth constituent items 310c, 320c, 330c, 340c, 350c, 360c, 370c, and 380c.

After obtaining the information about each constituent item, the output scheme changer 150 determines the item change ratio to change the size of each constituent item based on the changed size of the output space. Next, the output scheme changer 150 changes the size of each constituent item according to the item change ratio. The item change ratio may be determined by the above-described Inequality 1. The output scheme changer 150 determines the item change ratio by selecting the largest one of values satisfying the correlation such as Inequality 1. For example, when there are a plurality of values “c” such as ⅓, ¼, and ⅕ satisfying Inequality 1, the output scheme changer 150 determines ⅓ to be the item change ratio.

Referring to the respective constituent items 310a, 320a, 330a, 340a, 350a, 360a, 370a, and 380a of FIG. 3A and the respective constituent items 310c, 320c, 330c, 340c, 350c, 360c, 370c, and 380c of FIG. 3C, it may be seen that the item change ratio is determined to be ½, and the horizontal and vertical lengths of each constituent item may be reduced by ½ of the original lengths.

When the size of the constituent item is changed, the output scheme changer 150 rearranges the constituent items having changed sizes in the changed output space. In detail, the output scheme changer 150 arranges the constituent items having changed sizes in a plurality of frames included in the changed output space.

As described above, since the number of frames generated in the changed output space may be a reciprocal of the item change ratio, referring to FIG. 3C, two frames are generated in the changed output space. The frames in the output space may be implemented by a method of inserting a script to divide the output space into a plurality of frames in the web document about the webpage.

The output scheme changer 150 sequentially arranges the constituent items having changed sizes 310c, 320c, 330c, 340c, 350c, 360c, 370c, and 380c in the two frames. Since the size of the constituent item is changed as the item change ratio is applied to a value indicating the width and height of the constituent item of the script written in the web document about the webpage, an order of arranging the constituent items having changed sizes in the frames follows the order of arrangement of the constituent items in the output space of FIG. 3A.

The output scheme changer 150 changes the output scheme from the existing output scheme to an output scheme by which each constituent item having a reduced size is rearranged in the changed output space. The output scheme changed by the output scheme changer 150 is transferred to the change output device 170, and the change output device 170 outputs a result of the illustration of FIG. 3C on the user's terminal according to the changed output scheme.

Referring to FIG. 3C, as the output scheme changer 150 rearranges the constituent items having changed sizes in the changed output space, the output space of FIG. 3C may output more constituent items than the output space of FIG. 3A though the vertical length of the output space is reduced less than that of the output space of FIG. 3A. In detail, in the output space of FIG. 3C, the seventh constituent item 370a and the eighth constituent item 380a that are output only when the user presses the scroll button in the output space of FIG. 3A are output with their sizes changed (370c and 380c).

As described in FIGS. 3A, 3B, and 3C, according to the present inventive concept, even when the vertical length of the output space outputting the webpage is reduced as the user reduces the vertical length of the web browser window, the entire content of the webpage may be output through the output space having a reduced vertical length, the user may conveniently surf the web.

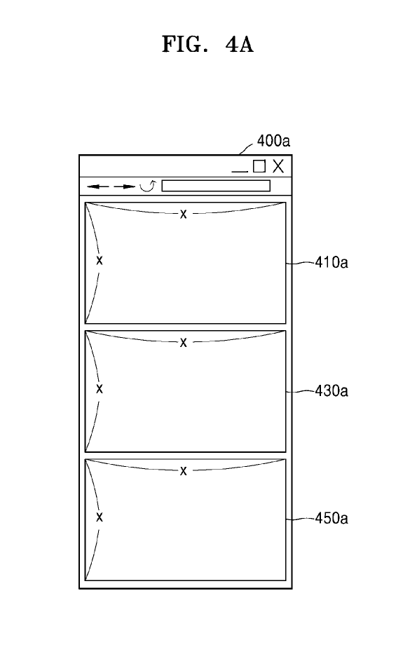

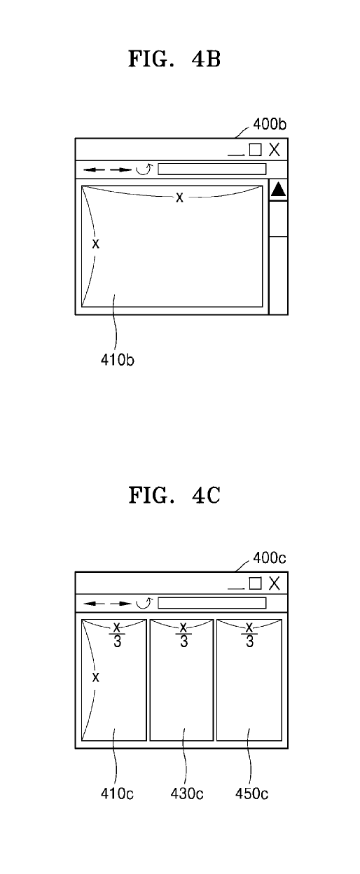

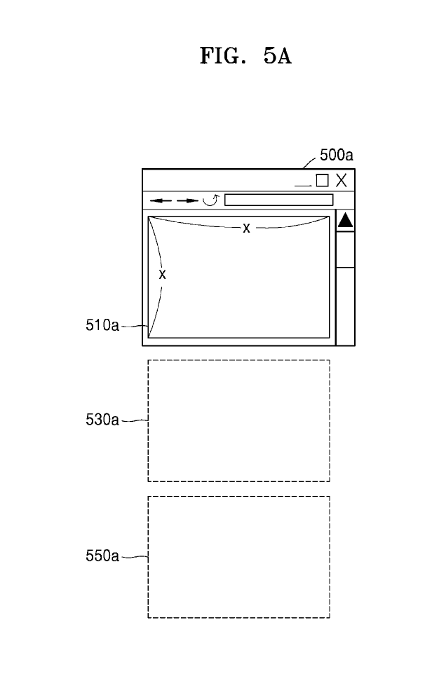

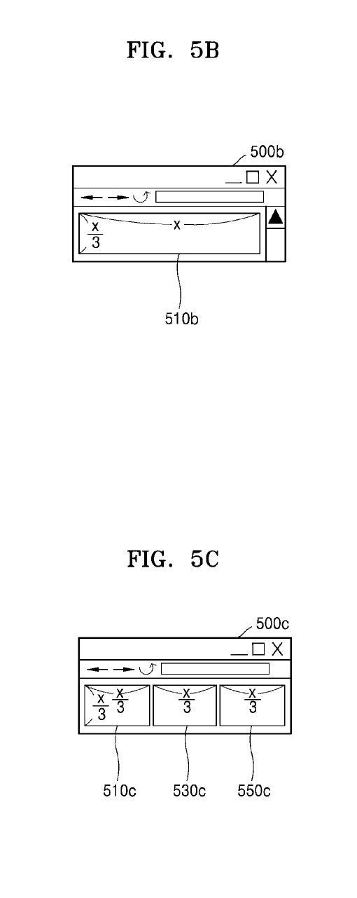

FIG. 3C illustrates a remaining space 390c. The remaining space 390c is generated due to a characteristic of the constituent item of the webpage that is reduced while keeping readability. The remaining space 390c may be included in a frame outputting a constituent item located at the bottom of the webpage among the frames included in the changed output space. The remaining space 390c may not exist according to the entire vertical length of the webpage or the changed size of the output space, as described below with reference to FIGS. 4 and 5.

FIGS. 4A, 4B, and 4C schematically illustrate an example of a webpage output scheme changed according to another embodiment.

Referring to FIG. 4A, a web browser window 400a includes an output space having a size before a change. A webpage including a first area 410a, a second area 430a, and a third area 450a is output through the output space having a size before a change.

In FIGS. 4A, 4B, and 4C, a horizontal length and a vertical length of each of the first area 410a, the second area 430a, and the third area 450a are all assumed to be “x”, and each of the first area 410a, the second area 430a, and the third area 450a may include at least one constituent item.

In FIG. 4A, the webpage is divided into the first area 410a, the second area 430a, and the third area 450a, each having the same horizontal length and vertical length, for convenience of explanation of FIG. 4A in relation with FIG. 4C. In FIG. 4A, the web browser window 400a including the output space having a size before a change does not include the scroll button. In other words, the output space included in the web browser window 400a of FIG. 4A outputs all constituent items constituting the webpage.

FIG. 4B illustrates a web browser window 400b to which the present inventive concept is not applied. The web browser window 400b to which the present inventive concept is not applied is a web browser window obtained by changing the size of the web browser window of FIG. 4A by the user, which outputs a first area 410b only. The first area 410b of FIG. 4B includes the same constituent item as the first area 410a of FIG. 4A.

Referring to FIG. 4B, it may be seen that the web browser window 400b of FIG. 4B no longer outputs the second area 430a and the third area 450a that were output in the output space having a size before a change of FIG. 4A. Accordingly, the web browser window 400b of FIG. 4B includes the scroll button to output the second area 430a and the third area 450a of FIG. 4A in the output space by receiving a user's input.

FIG. 4C illustrates a web browser window 400c to which the present inventive concept is applied. The web browser window 400c to which the present inventive concept is applied is a web browser window when the vertical length of the output space of the web browser window 400a of FIG. 4A is reduced to ⅓ by the user. A changed first area 410c, a changed second area 430c, and a changed third area 450c may be output through the changed output space.

Referring to FIGS. 4A, 4B, and 4C, when the vertical length of the output space of FIG. 4A is reduced, the output scheme changer 150 analyzes a script written in a web document about a webpage output in the output space, and obtains information about the position and the size, such as a width or a height, of each item constituting the webpage. The output scheme changer 150 obtains the information about each constituent item and then determines the item change ratio to change the size of each constituent item based on the changed size of the output space. Next, the output scheme changer 150 changes the size of each constituent item according to the item change ratio. The output scheme changer 150 compares the sizes of the output spaces of FIGS. 4A and 4C, identifies that the vertical length of the output space of FIG. 4A is reduced by ⅓, and determines the item change ratio based on the reduction.

Although, in most cases, the item change ratio may be determined by the above described Inequality 1, in the present embodiment, since, primarily, all constituent items of the webpage are output through the output space of the web browser window 400a having a size before the change and, secondarily, a degree of the size change of the output space is not much, there is no item change ratio satisfying the correlation such as Inequality 1.

In this case, in FIG. 4C, the output scheme changer 150 determines the direction, degree, and type of the size change of each constituent item based on the direction of the size change of the output space, the type of the size change of the output space, and the size change ratio.

According to the present embodiment, the output scheme changer 150 calculates a size change ratio of ⅓ based on the ratio by which the size of the output space is changed, and the calculated size change ratio is used as a standard for changing the size of each constituent item.

Furthermore, the output scheme changer 150 receives from the size change detector 110 and the pattern determiner 130 information that the direction of the size change of the output space and the type of the size change of the output space are, respectively, the direction along the vertical length of the output space and the reduction in the output space, and reduces each constituent item in the direction along the horizontal length. In other words, according to the present embodiment, the size change ratio and the type of the size change of the output space are applied to the change of the size of the constituent item without change, and the direction of the size change of the output space is reversely applied to the change of the size of the constituent item (the change of the vertical length of the output space changes the horizontal length of the constituent item).

When the size of the constituent item of each of the first to third areas 410a, 430a, and 450a is changed, the output scheme changer 150 rearranges the constituent items having changed sizes in the changed output space. In detail, the output scheme changer 150 arranges the constituent items having changed sizes in a plurality of frames included in the changed output space.

As described above, the number of frames generated in the changed output space may be a reciprocal of the item change ratio. Since the item change ratio in the present embodiment is ⅓, three frames are generated in the changed output space of FIG. 4C. The frames in the output space may be implemented by a method of inserting a script to divide one output space into a plurality of frames in the web document about the webpage.

The output scheme changer 150 sequentially arranges the constituent items having changed sizes in the three frames. Since the size of the constituent item is changed by applying the item change ratio to a value about the size, such as a width and a height, of the constituent item, of the script written in the web document of the webpage, an order of arranging the constituent items having changed sizes in the frames follows the order of arrangement of the constituent items in the output space of FIG. 4A.

Outputting the changed first area 410c, the changed second area 430c, and the changed third area 450c in the changed output space through the above process, as illustrated in FIG. 4C, is a new webpage output scheme changed by the output scheme changer 150. When FIG. 4A and FIG. 4C are compared with each other, each of the first to third areas 410a, 430a, and 450a of FIG. 4A and each of the first to third areas 410c, 430c, and 450c of FIG. 4C include the same constituent items. However, since the horizontal length of each the constituent items included in each of the first to third areas 410c, 430c, and 450c of FIG. 4C is identically compressed to ⅓ to be output in the changed output space, a font-stretch (a ratio of a horizontal width to a vertical length of a font) of a text of the constituent item included in each area decreases, or when the constituent item included in each area is an image, a resolution of the image is changed.

As illustrated in FIG. 4C, when all constituent items constituting the webpage are output in the output space having a size before a change, and the present inventive concept is applied thereto, the web browser window including the changed output space may not include a remaining space. However, in this case, the size change occurs only in one direction of the horizontal length and vertical length of the constituent item.

FIGS. 5A, 5B, and 5C schematically illustrate another example of a webpage output scheme changed by the output scheme changer 150.

Referring to FIGS. 5A, 5B, and 5C, it may be seen that a web browser window 500a includes an output space having a size before a change, and that only a first area 510a of a webpage is output in the output space. A second area 530a and a third area 550a of the webpage may be output in the output space having a size before a change when the user presses the scroll button. In other words, in FIG. 5A, unlike FIG. 4A described above, the web browser window 500a including the output space having a size before a change includes the scroll button.

In FIG. 5A, the webpage is divided into the first area 510a, the second area 530a, and the third area 550a, each having the same horizontal length and vertical length, for convenience of explanation of FIG. 5A in relation with FIG. 5C. Referring to FIG. 5A, the horizontal length and the vertical length of each of the first to third areas 510a, 530a, and 550a are the same as “x”, and each of the first to third areas 510a, 530a, and 550a may include one or more constituent items including content of the webpage.

FIG. 5B illustrates a web browser window 500b including an output space having a changed size. It is assumed that the present inventive concept is not applied to the web browser window 500b of FIG. 5B. Referring to FIG. 5B, the output space having a changed size outputs only a part of the content of the webpage corresponding to an upper area of the first area 510a of FIG. 5A. The web browser window 500b of FIG. 5B includes the scroll button to output the second area 530a and the third area 550a in FIG. 5A in the output space by receiving the user's input.

FIG. 5C illustrates a web browser window 500c to which the present inventive concept is applied.

The web browser window 500c of FIG. 5C, to which the present inventive concept is applied, is a web browser window when the vertical length of the output space of the web browser window 500a of FIG. 5A is reduced to ⅓ by the user. A changed first area 510c, a changed second area 530c, and a changed third area 550c may be output through the changed output space.

Referring to FIGS. 5A, 5B, and 5C, when the vertical length of the output space of FIG. 5A is reduced, the output scheme changer 150 analyzes a script written in a web document about a webpage output in the output space, and obtains information about the position and the size, such as a width or a height, of each item constituting the webpage. The output scheme changer 150 obtains the information about each constituent item and then determines the item change ratio to change the size of each constituent item based on the changed size of the output space. Next, the output scheme changer 150 changes the size of each constituent item according to the item change ratio. The output scheme changer 150 compares the sizes of the output spaces of FIGS. 5A and 5C, identifies that the vertical length of the output space of FIG. 5A is reduced by ⅓, and determines the item change ratio.

According to the above-described Inequality 1, the item change ratio may be determined to be ⅓ according to a ratio of the entire vertical length of the webpage and the vertical length of the output space having a changed size. The output scheme changer 150 reduces the horizontal length and the vertical length of the constituent item included in the webpage to ⅓.

When the size of the constituent item is changed, the output scheme changer 150 rearranges the constituent items having changed sizes in the changed output space. In detail, the output scheme changer 150 arranges the constituent items having changed sizes in a plurality of frames included in the changed output space.

As described above, since the number of frames generated in the changed output space may be a reciprocal of the item change ratio, referring to FIG. 5C, three frames are generated in the changed output space. The frames in the output space may be implemented by a method of inserting a script to divide one output space into a plurality of frames in the web document about the webpage.

The output scheme changer 150 sequentially arranges the constituent items having changed sizes in the three frames. Since the size of the constituent item is changed by applying the item change ratio to the script in the web document about the webpage, the order of arranging the constituent items having changed sizes follows the order of arrangement of the constituent items in the output space of FIG. 5A.

Outputting the changed first area 510c, the changed second area 530c, and the changed third area 550c in the changed output space through the above process, as illustrated in FIG. 5C, is a new webpage output scheme changed by the output scheme changer 150.

Finally, the output scheme changer 150 defines a new output scheme based on the determined reduction ratio of the constituent item and the information about the rearrangement of the reduced constituent items, and changes an existing output scheme to be a newly defined output scheme. The change output device 170 described below outputs an image of FIG. 5C through the user's terminal by the changed output scheme.

When comparing FIG. 5A and FIG. 5C with each other, each of the first to third areas 510a, 530a, and 550a of FIG. 5A and each of the first to third areas 510c, 530c, and 550c of FIG. 5C include the same constituent items.

However, since the horizontal length of each the constituent items included in each of the first to third areas 510c, 530c, and 550c of FIG. 5C is identically compressed to ⅓ to be output in the changed output space, a font-stretch (a ratio of a horizontal width to a vertical length of a font) of a text of the constituent item included in each area decreases, or when the constituent item included in each area is an image, a ratio of a horizontal length to a vertical length of an image is not changed.

As illustrated in FIG. 5C, when both sides of Inequality 1 are identical according to the entire vertical length of the webpage and the changed size of the output space, the web browser window including the changed output space may not include the remaining space.

FIGS. 6A, 6B, 6C, and 6D schematically illustrate that a plurality of frames included in a changed output space are distinguished by Inequality 1.

Since the determining of the item change ratio through Inequality 1 is one of various methods to implement the present inventive concept, even when a plurality of frames are generated in the changed output space unlike the illustration of FIG. 6, if the present inventive concept is performed by including another configuration of the present inventive concept, it may be the same as the implementation of the present inventive concept.

As described above in the description of Inequality 1, the output scheme changer 150 determines the item change ratio through the correlation such as Inequality 1, and the number of frames included in the changed output space is determined to be a reciprocal of the item change ratio, in order to output the entire content included in the webpage in the changed output space.

Referring to FIG. 6A, a web browser window 600a includes an output space having a size before a change, and only a first area 610a of a webpage is output in the output space having a size before the change. As the user presses the scroll button included in the web browser window 600a, a second area 630a of the webpage may be output in the output space having a size before the change. Since the entire vertical length of the webpage is “a”, the vertical length of the output space having a size before the change is “b₀”. In other words, since the entire vertical length of the webpage exceeds the vertical length of the output space, the entire content of the webpage is not output through the output space before the change.

FIG. 6B schematically illustrates the number of frames included in the changed output space when the vertical length of the output space of the web browser window 600a of FIG. 6A is reduced from “b₀” to “b₁”. Assuming that a value obtained by dividing “b₁” by “a” is greater than or equal to ¼, the item change ratio is ½, and the number of frames included in the changed output space is two, as illustrated in FIG. 6B.

FIG. 6C schematically illustrates the number of frames included in the changed output space when the vertical length of the output space of the web browser window 600a of FIG. 6A is reduced from “b₀” to “b₂”. Assuming that a value obtained by dividing “b₂” by “a” is greater than or equal to 1/9, the item change ratio is ⅓, and the number of frames included in the changed output space is three, as illustrated in FIG. 6C.

FIG. 6D schematically illustrates the number of frames included in the changed output space when the vertical length of the output space of the web browser window 600a of FIG. 6A is reduced from “b₀” to “b₃”. Assuming that a value obtained by dividing “b₃” by “a” is greater than or equal to 1/16, the item change ratio is ¼, and the number of frames included in the changed output space is four, as illustrated in FIG. 6D.

In summary, when the vertical length of the output space included in the web browser window 600a of FIG. 6A to which the present inventive concept is applied is reduced, and the reduced vertical length corresponds to the previously stored size change pattern, the output scheme changer 150 may change the output scheme so as to output the entire content of the webpage through a plurality of frames included in one web browser window, as illustrated in FIGS. 6B to 6D.

Consequently, referring to FIG. 6A, conventionally, the user needs to search the webpage in a vertical direction by pressing the scroll button to access the entire content of the webpage. Referring to FIGS. 6B to 6D in which the present inventive concept is implemented, the user changes the size of the output space without performing a scroll operation, and thus the entire content of the webpage may be viewed at a glance.

In another embodiment that is different from the above-described embodiments, the output scheme changer 150 may calculate an expanded output space in which the horizontal length of the changed output space is additionally expanded according to the size change ratio. The constituent items constituting the webpage may be output in the expanded output space according to the changed output scheme by the change output device 170 that is described below.

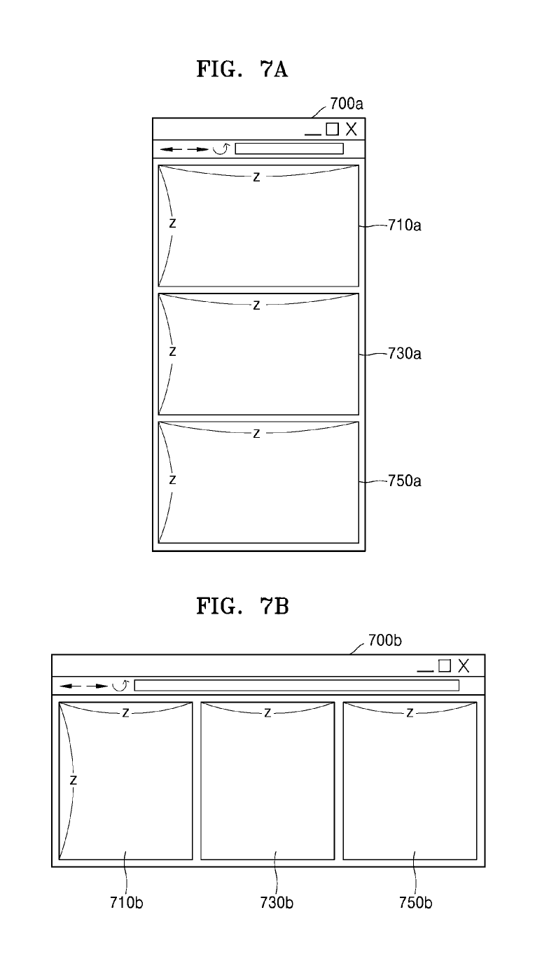

FIGS. 7A and 7B schematically illustrate another embodiment of a webpage output scheme changed by the output scheme changer 150.

Referring to FIG. 7A, a web browser window 700a may include an output space having a size before a change, through which a first area 710a, a second area 730a, and a third area 750a of a webpage are output. The first to third areas 710a, 730a, and 750a are determined based on relative positions of the areas in the webpage, for convenience of explanation. Each of the first to third areas 710a, 730a, and 750a of FIG. 7A may include at least one constituent item.

In FIG. 7A, it is assumed that the horizontal length and the vertical length of each of the first area 710a, the second area 730a, and the third area 750a are identically set to be “z”, and that the vertical length of the output space outputting the webpage is reduced to ⅓ of the vertical length of the output space by the user's input. In other words, according to the above-description, the size change ratio in the present embodiment is ⅓.

First, the output scheme changer 150 calculates an expansion ratio of the output space based on the reduced vertical length of the output space. In the present embodiment, since the vertical length of the output space of FIG. 7A is reduced to ⅓ of the vertical length of the output space, the output scheme changer 150 determines an expansion ratio of the changed output space to be 3.

The output scheme changer 150 calculates an expanded output space by increasing the horizontal length of the changed output space by three times according to the expansion ratio. The output scheme changer 150 defines rearrangement of the constituent items constituting the webpage horizontally in the expanded output space to be a new output scheme, and changes an existing output scheme to a newly defined output scheme.

In the embodiment of the present inventive concept according to FIG. 7, although the vertical length of the output space is reduced, the horizontal length of the output space is expanded based on the reduced vertical length. Consequently, only an arrangement direction is changed without changing the size of the constituent item of the webpage. In other words, each of the first to third areas 710a, 730a, and 750a of FIG. 7A and each of the first to third areas 710b, 730b, and 750b of FIG. 7B may include the same content. Also, the web browser window 700a of FIG. 7A and a web browser window 700b of FIG. 7B may all output the entire content of the webpage corresponding to a webpage address.

In the apparatus for changing a webpage output scheme according to the present embodiment, since the user's reduction in the vertical length of the output space is regarded to be an intention to view the webpage in the horizontal direction and thus the output scheme is changed such that the webpage is arranged and output long in the horizontal direction, user convenience in surfing the web may be improved.

In the present embodiment, when calculating an expanded output space, the output scheme changer 150 may receive a horizontal length of a display of a user's terminal as a variable, and may use an input variable for calculating the expanded output space. The output scheme changer 150 receives the horizontal length of the display of a user's terminal as a variable because the horizontal length of the expanded output space is excessively expanded as a size change ratio decreases and thus the expanded output space may not be properly displayed on the display of a user's terminal.

Thus, in the present inventive concept, in order to prevent the excessive expansion of the horizontal length of the expanded output space, when the size change of the output space by the user is detected, the effective change points are displayed and the webpage output scheme may be set not to be changed in response to the user's input beyond the effective change points.

The change output device 170 may output the webpage through the changed output space according to the output scheme changed by the output scheme changer 150, and may include a space remover 171 and a space expander 173.

In detail, the change output device 170 receives the changed output scheme from the output scheme changer 150, and arranges and outputs the constituent items of the webpage according to the received changed output scheme. The changed output scheme that the change output device 170 received from the output scheme changer 150 may include information about an arrangement position of each item constituting the webpage, information about an expansion or reduction ratio of each constituent item by the item change ratio, and information about the number of frames included in the output space.

In some embodiments, the change output device 170 may output the webpage through the expanded output space according to the changed output scheme. The expanded output space may signify the output space produced by further expanding the horizontal length of the changed output space according to the size change ratio, in the above-described embodiment of the output scheme changer 150, and a schematic description thereof is already presented in FIG. 7.

In some embodiments, the change output device 170 may divide the changed output space into a plurality of individual output spaces. An individual output space may signify a space for outputting each constituent item rearranged by an output scheme changed by the output scheme changer 150. In other words, the individual output space may be defined to be a small output space included in the output space. To distinguish each individual output space, a unique identification sign is assigned to each individual output space, which is written in the web document about the webpage.

Each individual output space may include a space removal button that may be selected by the user. Being selected by the user may signify receiving an input when the user applies an input through an input device. The input device may include not only a general mouse or keyboard but also a touch screen.

The space removal button may signify a button displayed in the individual output space and capable of receiving the user's input. The space removal button, when selected by the user, may transfer the section by the user to the space remover 171.

When the user selects the space removal button, the space remover 171 removes the individual output space including the space removal button selected by the user.

The identification sign assigned to each individual output space is mapped with information about the size of each individual output space and information about the position of an individual output space in the changed output space. The information about the size of each individual output space is stored in the change output device 170.

The space remover 171 may remove the individual output space and collect the identification sign of the removed individual output space, and then may transmit the identification sign of the removed individual output space and information about the size of the removed individual output space mapped with the identification sign of the removed individual output space.

The space expander 173 identifies an individual output space that is expandable by a space produced by the removed individual output space, and expands the identified individual output space.

First, the space expander 173 receives from the space remover 171 information about the identification sign of the removed individual output space and the size of the removed individual output space.

Next, the space expander 173 identifies a position of the removed individual output space in the output space based on the identification sign of the removed individual output space, and identifies the individual output space that is expandable by the removed individual output space.

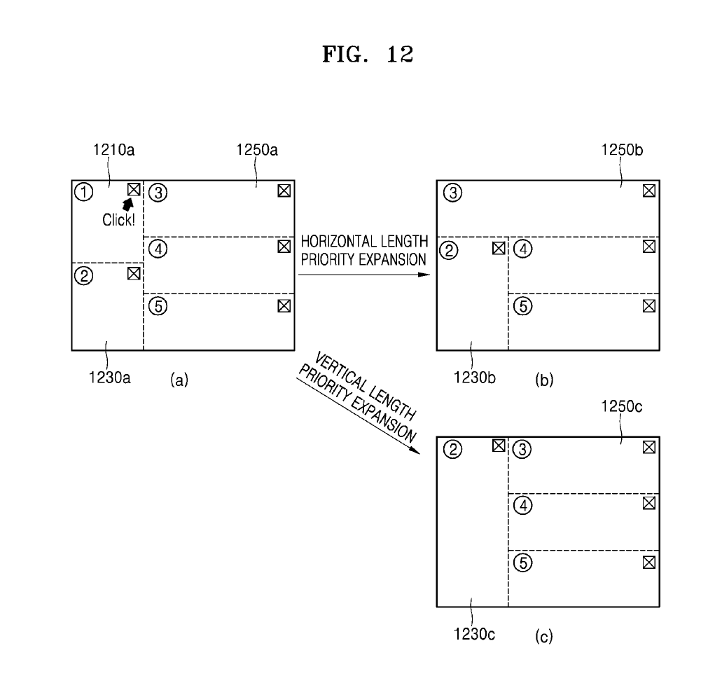

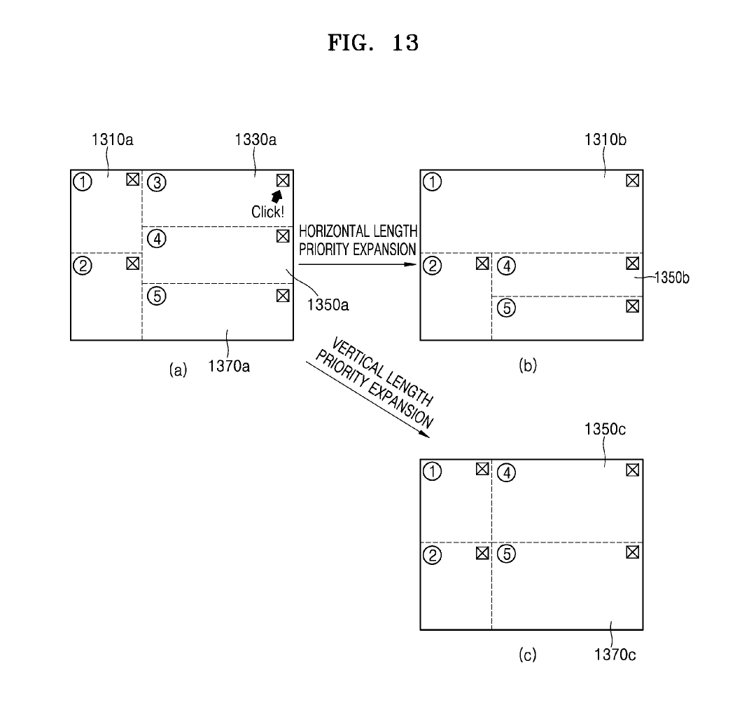

In detail, the space expander 173 may identify an individual output space that is expandable in an expansion priority direction by the space produced as the individual output space is removed, to be an expandable individual output space. The expansion priority direction may signify a direction in which an individual output space is expanded with priority when the individual output space is expanded by the space expander 173, and a schematic description of the expansion priority direction is presented below in FIGS. 12 and 13.

The expandable individual output space is not limited to an individual output space immediately adjacent to the removed individual output space. Furthermore, there may be at least one individual output space adjacent to the removed individual output space that is expandable in size, and when there are a plurality of individual output spaces, at least one individual output space may be selected according to a preset expansion priority direction.

When the individual output space that is expandable in size is selected, the space expander 173 combines the removed individual output space with the selected individual output space, thereby expanding the size of the selected individual output space. In this case, when a plurality of selected individual output spaces are provided, the space expander 173 may divide the size of the removed individual output space by the number of the selected individual output spaces and then expand the selected individual output space by the divided size of the removed individual output space.

When the individual output space is expanded, the space expander 173 transfers information about the sizes and positions of all individual output spaces including the expanded individual output space to the output scheme changer 150.

The output scheme changer 150 changes the size of the constituent item output in each individual output space based on the information about the size and position of the individual output space, changes the output scheme to rearrange the constituent item having a changed size in each individual output space, and transfers the changed output scheme to the change output device 170. The change output device 170 outputs the webpage according to the received output scheme.

A process that the output scheme changer 150 changes the size of the constituent item output in each individual output space and rearranges the constituent item having a changed size in each individual output space based on the information about the size and position of the individual output space calculated by the space expander 173 is performed by the above-described method in FIGS. 3 to 6.

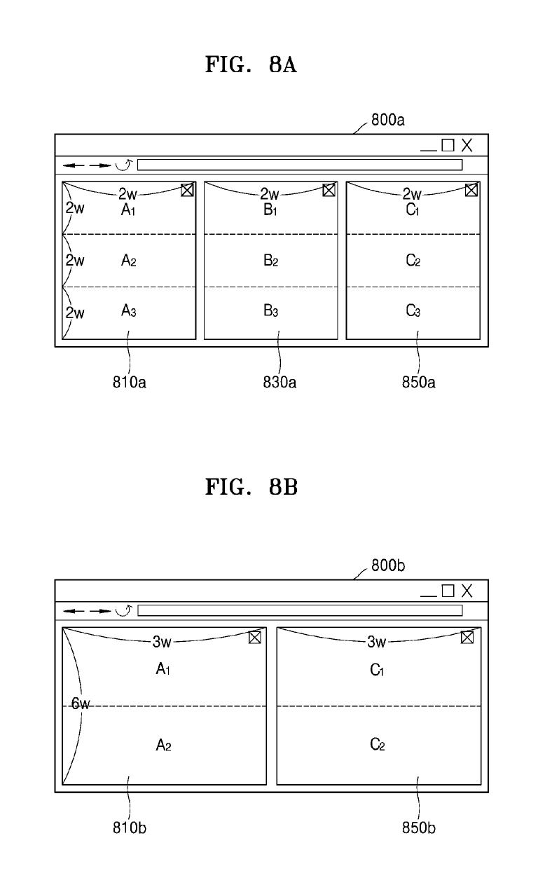

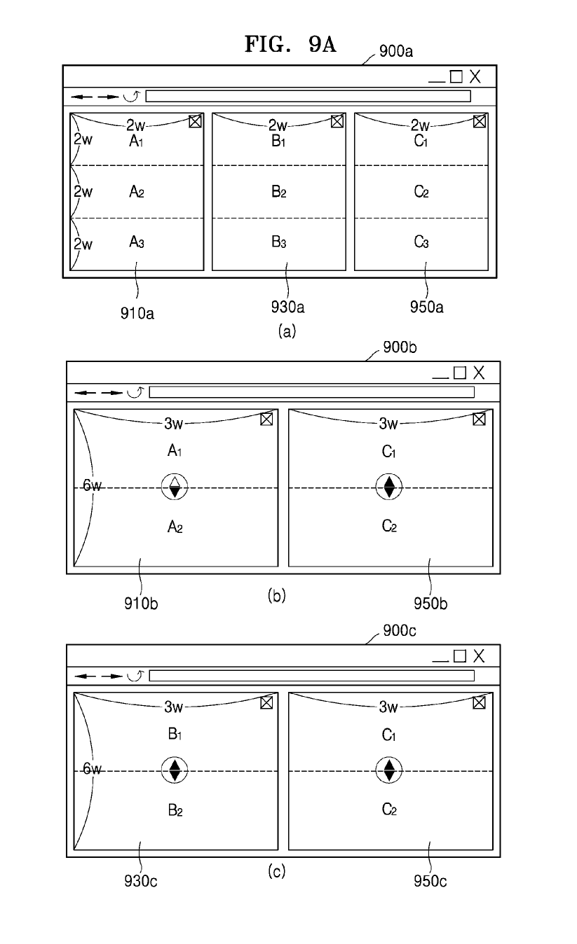

FIGS. 8A and 8B schematically illustrate an example of a web browser window for explaining a space remover and a space expander.

For convenience of explanation, the output scheme changer 150, the change output device 170, the space remover 171, and the space expander 173 of FIG. 1 are referred to.

In FIG. 8A, a first area 810a, a second area 830a, and a third area 850a are output in three individual output spaces. The individual output spaces are assumed to be divided by a boundary indicated by a dashed line. Furthermore, it is assumed that the first area 810a, the second area 830a, the third area 850a altogether form one webpage, and that each area includes a plurality of constituent items forming one webpage.

When the user selects the space removal button included in an individual output space outputting the second area 830a, the space remover 171 may remove a middle individual output space by detecting a user's input, and may transfer to the space expander 173 the identification sign of a removed individual output space and information about the size of the removed individual output space.

The space expander 173 receives the identification sign of the individual output space from the space remover 171 to identify that the individual output space that needs to be expanded is the individual output spaces at opposite ends, and divides the size of the removed individual output space into two and adds the divided sizes to the remaining individual output spaces. As a result, only two individual output spaces are left.

When the individual output space is expanded, the space expander 173 transfers information about the sizes and positions of all individual output spaces including the expanded individual output space to the output scheme changer 150.

The output scheme changer 150 changes the output scheme based on the information about the size and position of the expanded individual output space, and transfers the changed output scheme to the change output device 170. In this state, the horizontal length and the vertical length of the constituent item output in the expanded individual output space is expanded according to a ratio of the expanded individual output space. The change output device 170 receives the output scheme regarding the expanded individual output space from the output scheme changer 150, and outputs the webpage through the expanded individual output space according to the received output scheme.

FIG. 8B illustrates the individual output spaces 810b and 850b that are two output spaces left by the space expander 173. When FIG. 8A and FIG. 8B are compared with each other, it may be seen that content A3 of the webpage output in the first area 810a of FIG. 8A is no longer output in a first area 810b of FIG. 8B in the expanded individual output space, due to the expansion of the individual output space. This is because the output scheme is changed such that the horizontal length and the vertical length of the constituent item are expanded altogether as the individual output space is expanded.

In some embodiments, the change output device 170 may include the scroll button in the changed output space and output the included scroll button, when outputting the webpage through the changed output space according to the changed output scheme. Since the individual output space is a kind of the output space, the change output device 170 may include the scroll button in the individual output space and output the included scroll button. A method of including the scroll button in the individual output space and outputting the included scroll button follows the method of including the scroll button in the output space and outputting the included scroll button. The scroll button displayed in the output space performs a function similar to the function of the scroll button that is included in a general window and operated. First, the scroll button displayed in the output space may include arrows indicating up and down directions, and perform the same function as a general scroll button in receiving the user's input and outputting an area different from a webpage area currently displayed in the output space.

However, the scroll button displayed in the output space is displayed in a webpage area output in the individual output space, and does not have a fixed position. Furthermore, in order not to prevent the user from accessing the content of the webpage, the scroll button is displayed semi-transparently in the output space or is set to be displayed in the output space only by a specific gesture of the user, which is different from the general scroll button.

Assuming that there are a plurality of individual output spaces and the scroll button is displayed in a part of the individual output space, the scroll button may change the webpage area output in the individual output space according to the following process.

First, when a user's input on the scroll button is detected, the detected user's input is transferred to the change output device 170. The change output device 170 may recognize, from the user's input, the webpage area that the user wants to see through the scroll button.

The change output device 170 changes the webpage area output in the individual output space displaying the scroll button that received the user's input, based on the recognized user's intention. For example, when the user presses an upward button in the scroll button, the change output device 170 may output an area located above the webpage area currently output in the individual output space, through the individual output space in which the scroll button that received the user's input is displayed.

The present inventive concept provides an effect of allowing a user to view the entire content output by the webpage at a glance without using the scroll button. In a general case, the scroll button does not need to be displayed in the individual output space. However, since the present inventive concept may include the space removal button in the individual output, and when the user's input is applied to the space removal button, a part of the individual output spaces may be removed, the scroll button is needed to see, in the remaining individual output space, the webpage area that is already output through the removed individual output space.

Next, a process of displaying the scroll button in the expanded individual output space is described.

First, when the space removal button is selected by the user, the space remover 171 removes the individual output space including the selected space removal button. In this state, the space remover 171 may collect the identification sign of the removed individual output space, and may transfer the information about the webpage area output in the removed individual output space to the space expander 173.

The space expander 173 expands the individual output space adjacent to the removed individual output space as large as the removed individual output space, and adds information about the webpage area output in the removed individual output space to the information about the webpage area output in the expanded individual output space.

The change output device 170 includes the scroll button in the expanded individual output space and outputs the included scroll button, when the information about the webpage area output in expanded individual output space includes the information about the webpage area output in the removed individual output space.

After the above process, while there is no change in outputting the same webpage area before the expansion in the expanded individual output space, as the user presses the scroll button displayed in the expanded individual output space, the webpage area output in the removed individual output space may be accessed through the expanded individual output space.

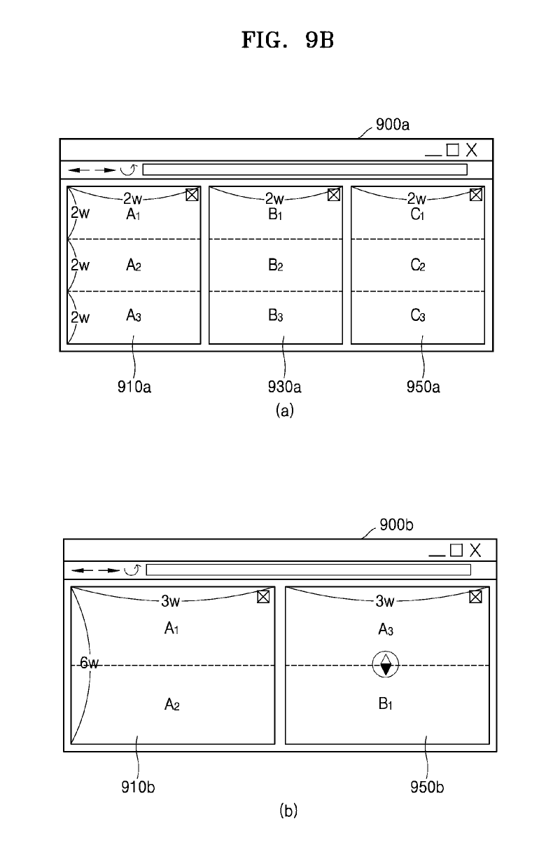

FIG. 9A schematically illustrates an example of the scroll button displayed in the individual output space.

In (a) of FIG. 9A, a first area, a second area, and a third area are output in three individual output spaces 910a, 930a, and 950a, respectively. It is assumed that the first, second, and third areas constitute one webpage and each area includes at least one constituent item constituting the webpage. Furthermore, it is assumed that the first, second, and third areas illustrated in (a) of FIG. 9A are a horizontal arrangement according to the present inventive concept of one webpage that is output long in the vertical direction, like the web browser window of FIG. 3A, and that a space output option is set to give priority to the webpage area that is output.

The space output option is an example of a setting value included in the space expander 173, which is a reference to determine the webpage area that is output through the expanded individual output space after the individual output space is removed. When the individual output space is removed, the space expander 173 expands the remaining individual output space, and changes the webpage area that is output through the expanded individual output space, according to the setting of the space output option.

As an example of the space output option, when the space output option is set to give priority to the webpage area that is output, the space expander 173 may prevent the webpage output through the individual output space removed by the user from being output through the expanded individual output space, based on the set space output option. The webpage area that is not to be output may be accessed only when the user presses the scroll button displayed in the expanded individual output space.

A detailed description of the above-described example is schematically described with reference to FIG. 9A, and a description of another example of the space output option is described below with reference to FIG. 9B. The space output option may be previously set with default values by a system operator of the apparatus for changing a webpage output scheme according to the present inventive concept, and the user may freely change the previously set space output option through an environment setting of the web browser.

In (a) of FIG. 9A, when the user selects the space removal button in an individual output space 930a where a second area is arranged, the space remover 171 may detect the user's input, remove the individual output space 930a in the middle of the individual output space 930a, and transfer to the space expander 173 information about the identification sign and size of the removed individual output space.

The space expander 173 receives the identification sign of the individual output space from the space remover 171, recognizes that individual output spaces to be expanded are individual output spaces 910a and 950a at the opposite sides with respect to the individual output space 930a, and divides the size of the removed individual output space and adds the divided sizes to the remaining individual output spaces. As a result, only two individual output spaces are left.

(b) of FIG. 9A illustrates a web browser window 900b in which only two individual output spaces 910b and 950b are left after the above process. However, (b) of FIG. 9A is different from FIG. 8B in that a semitransparent scroll button is displayed in each individual output space.

Referring to (b) of FIG. 9A, as the user presses the scroll button of the left individual output space 910b or the scroll button of the right individual output space 950b, the webpage area that is already output in the removed individual output space may be output. In other words, the scroll button displayed in each individual output space may perform, by receiving the user's input, a function of outputting the constituent item arranged above or under the constituent item output in the individual output space.

Furthermore, as the individual output spaces 910a and 950a of (a) of FIG. 9A are respectively expanded to the individual output spaces 910b and 950b of (b) of FIG. 9A, the output scheme of the constituent item output through each of the individual output spaces 910a and 950a of (a) of FIG. 9A is changed. In other words, referring to (b) of FIG. 9A, it may be seen that contents A3 and C3 of the webpage output in (a) of FIG. 9A are no longer output.

Although the scroll button displayed in the individual output space provides user convenience to access the individual output space that the user removed due to no further necessity, when the respective areas output in the individual output space are arranged vertically, a complete webpage is formed due to the functional properties of an up/down scroll.

(c) of FIG. 9A is another example illustrating a result when the individual output space 910a where the first area is arranged is removed in (a) of FIG. 9A.

Furthermore, as the individual output spaces 930a and 950a of (a) of FIG. 9A are expanded to the individual output spaces 930c and 950c of (c) of FIG. 9A, the output scheme of the constituent item output through each of the individual output spaces 910a and 950a of (a) of FIG. 9A is changed. In other words, referring to (c) of FIG. 9A, it may be seen that contents B3 and C3 of the webpage output in (a) of FIG. 9A are no longer output.

FIG. 9B schematically illustrates another example of the scroll button displayed in the individual output space.

In (a) of FIG. 9B, the first, second, and third areas are output in the three individual output spaces 910a, 930a, and 950a, respectively. It is assumed that the first, second, and third areas constitute one webpage and each area includes at least one constituent item constituting the webpage. Furthermore, it is assumed that the first, second, and third areas illustrated in (a) of FIG. 9B are a horizontal arrangement according to the present inventive concept of one webpage that is output long in the vertical direction, like the web browser window of FIG. 3A, and that a space output option is set to give priority to the webpage area that is output.

When the user selects the space removal button in the individual output space 930a where the second area is arranged, the space remover 171 may detect the user's input, remove the individual output space 930a in the middle of the individual output space 930a, and transfer to the space expander 173 information about the identification sign and size of the removed individual output space.

The space expander 173 receives the identification sign of the individual output space from the space remover 171, recognizes that individual output spaces to be expanded are the individual output spaces 910a and 950a at the opposite sides with respect to the individual output space 930a, and divides the size of the removed individual output space and adds the divided sizes to the remaining individual output spaces. As a result, only two individual output spaces are left.

As an example of the space output option different from the above description, when the space output option is set to give the priority to the number of individual output spaces, the space expander 173 may sequentially output the webpage through the expanded two individual output spaces 910b and 950b based on the set space output option. The webpage that is sequentially output may signify the webpage in which the constituent items are arranged and output in an order that the webpage before the output scheme is changed is output in a general web browser window.

In comparison between (b) of FIG. 9A and (b) of FIG. 9B, since in (b) of FIG. 9A the space output option is set to give priority to the webpage area that is output, the first area and the third area of the webpage output through the individual output spaces 910a and 950a in (a) of FIG. 9A that are not removed as the user's input is not pressed are output through the expanded individual output spaces 910b and 950b in (b) of FIG. 9A.

In contrast, since in (b) of FIG. 9B the space output option is set to give priority to the number of individual output spaces, when each of the individual output spaces 910a and 950a in (a) of FIG. 9A is expanded by the space expander 173, the first area and the second area of the webpage output through the individual output space of (a) of FIG. 9B are output through the expanded individual output spaces 910b and 950b in (b) of FIG. 9A.

A process of implementing (b) of FIG. 9B is the same as (b) of FIG. 9A until the two expanded individual output spaces 910b and 950b of (b) of FIG. 9B are generated, but is different from (b) of FIG. 9A in that the space expander 173 recognizes that the space setting option is set to give priority to the number of individual output spaces, and then expands the size of the size of the webpage area according thereto and outputs an expanded webpage area through the expanded individual output space.

In detail, first, when the space removal button is selected by the user, the space remover 171 removes the individual output space including the selected space removal button. In this state, the space remover 171 collects the identification sign of the removed individual output space.

The space expander 173 expands the individual output space adjacent to the removed individual output space as large as the removed individual output space based on the collected identification sign, determines a ratio to expand the webpage area according to the size of the expanded individual output space, and sequentially outputs the expanded webpage area through the expanded individual output space. In other words, referring to (b) of FIG. 9B, it may be seen that only contents A1, A2, A3, and B1 located in an upper portion of the webpage are output through the expanded individual output spaces 910b and 950b.

In other words, when the space output option is set to give priority to the webpage that is output, the webpage area output in the individual output space that the user removes may be output through the expanded individual output space only when the user presses the scroll button in the expanded individual output space. the present embodiment is suggested because the user's removal of a particular individual output space through the space removal button may be interpreted that the user does not need to see the webpage area that is output through the individual output space that the user removes.

In contrast, when the space output option is set to give priority to the number of individual output spaces, the webpage area output through the individual output space that the user removed may be output through the expanded individual output space. In other words, according to the present embodiment, regardless of the individual output space that the user removed, the webpage area that is finally output through the web browser window is the same. The present embodiment is suggested because the user's removal of a particular individual output space through the space removal button may be interpreted that the user wants to see the webpage through a less number of individual output spaces.

In the apparatus for changing a webpage output scheme according to another embodiment of the present inventive concept, the output space may be one of output areas included in a combined webpage including a plurality of output areas. Each output area may signify an area where an independent webpage is output, and the size of each output area may be changed.

In the present embodiment, the combined webpage is a webpage that is output when the user inputs a webpage address to output the combined webpage in an address section of a web browser window, and signifies a webpage having a plurality of output areas, in each of which an independent webpage is output. To include a plurality of output areas, a script to divide the output space of the web browser window into a plurality of output areas is written in a web document of the combined webpage.

Dividing the output space of the web browser window into a plurality of output areas is written in a web document when a creator of a website that the user accesses creates the web document about the website.

For example, it is assumed that there is a creator operating a combined webpage in which five different home shopping mall sites are output in one output space. In the above example, assuming that a creator of the combined webpage writes a web document about the combined webpage by HTML, in the web document, five output areas area generated, a site address of a different home shopping mall is written in each output area through a link tag such as ‘a href’, and a script about a ‘noresize’ tag may not be written so that the size of each output area may be freely changed.

In the above example, the creator of the combined webpage may use a ‘name’ tag to distinguish the respective output areas. In the following description, in the web document, a tag or sign inserted to distinguish the respective output area is collectively referred to as the identification sign.

In other words, in the present embodiment, the output area is characteristically identical to the output space in that it is an area in which a webpage having a changeable size may be output. When the size of the output area is changed, the output scheme of the webpage output in the output area may be changed.

FIG. 11 schematically illustrates a combined webpage having a plurality of output areas according to an embodiment.

Referring to FIG. 11, a web browser window 1100 may include a webpage address input section 1110 and five the output areas 1120, 1130, 1140, 1150, and 1160 t o which identification signs from 1 to 5 are assigned.

The webpage address input section 1110 receives a webpage address from the user and outputs a webpage corresponding to the webpage address in the output space of the web browser window 1100. As an address of a combined webpage defining five output areas is input in the webpage address input section 1110, the output space of the web browser window 1100 is output by being divided into five output areas 1120, 1130, 1140, 1150, and 1160. Information about the identification signs, sizes, and positions of the five output areas is written as a script in the web document about the combined webpage.

The five output areas 1120, 1130, 1140, 1150, and 1160 each output the content according to the descriptions written in the web document about the combined webpage. Since the web document about the combined webpage defines that the size of each output area is changeable, the size of each output area may be changed by receiving the user's input. When the size of the output area is changed, the output scheme of a webpage output in the output area is changed according to the apparatus for changing a webpage output scheme according to the present inventive concept. The process of changing a webpage output scheme is described above in FIGS. 2 to 6.

When a multiple of webpages are output through one web browser window as illustrated in FIG. 11, the user is able to work while viewing several webpages varying in real time at a glance, and thus efficiency of work may be improved.

Furthermore, since a plurality of output areas provided in the combined webpage may be operated according to the above-described embodiments of FIGS. 3 to 10, the user may remove the output area that does not need to be open any longer or may change the size of the output area outputting a particular webpage. As the scroll button is displayed in the five output areas 1120, 1130, 1140, 1150, and 1160 of FIG. 11 as described above in FIGS. 9A and 9B, the user may easily read the webpage that is output in each output space.

In an embodiment of the web browser window outputting the combined webpage having a plurality of output areas, when any one of the output areas included in a web browser window is expanded over a certain ratio, the output areas other than the expanded output area may be removed and the webpage output in the expanded output area may be displayed only in one output space.

The above embodiment is suggested because the user's expanding one output area over a certain ratio may be interpreted that the user does not need output areas other than the expanded output area any longer. In the embodiment, the removing or expanding of the output area may be performed by the above-described space remover 171 and space expander 173.

FIG. 12 schematically illustrates a result of removing one output area from a web browser window outputting a combined webpage having a plurality of output areas.

In FIG. 12, it is assumed that the number indicated in each output area is an identification sign to distinguish the respective output areas, and that each output area includes the space removal button, for convenience of explanation, the space remover 171 and the space expander 173 of FIG. 1 are referred to. When the present inventive concept is actually implemented, the indication of the identification signs to distinguish the respective output areas may be omitted.

(a) of FIG. 12 illustrates a web browser window before an output area corresponding to identification sign 1 is removed from the web browser window including a plurality of output areas, in which a web browser window may include five output areas including an output area 1210a corresponding to identification sign 1, an output area 1230a corresponding to identification sign 2, and an output area 1250a corresponding to identification sign 3.

A unique identification sign is assigned by the creator of the combined webpage to each output area included in the web browser window 1200a. As described above, the identification sign is defined corresponding to each output area to distinguish a plurality of output areas, in the web document about the combined webpage. This is to allow each output area to output a webpage corresponding to other webpage address, and when a user's input about the space removal button is received, to remove the output area including the space removal button that received the user's input and to identify an output area to be expanded.

(b) of FIG. 12 illustrates the arrangement of the output areas when the output area 1210a corresponding to identification sign 1 is removed and a horizontal length is set as the expansion priority direction in the space expander 173. A user surfing the web through the web browser window according to the present inventive concept may determine the expansion priority direction to be one of a horizontal length direction and a vertical length direction through an environment setting window of the web browser window.

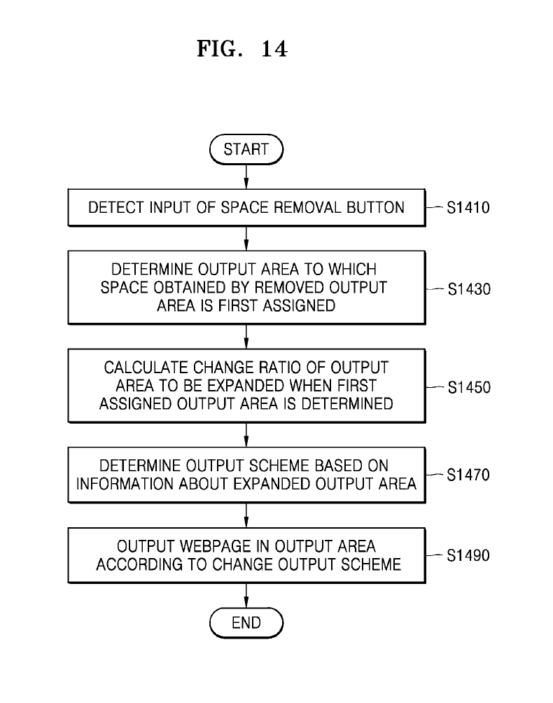

Since the direction along the horizontal length is set as the expansion priority direction in the space expander 173, the output area 1250a corresponding to identification sign 3 is expanded to an output area 1250b corresponding to identification sign 3 that is expanded, by the output area 1210a corresponding to identification sign 1 that is removed. In this process, the vertical length of an output area 1230a corresponding to identification sign 2 is partially expanded as the output area 1210a corresponding to identification sign 1 is removed. The process of the expansion of the vertical length of the output area 1230a corresponding to identification sign 2 is described in detail with reference to the flowchart of FIG. 14. When the output scheme of the webpage that is output through the output area 1250b corresponding to identification sign 3 that is expanded is changed by the output scheme changer 150, the change output device 170 outputs the webpage through the output area 1250b corresponding to identification sign 3 that is expanded, according to the changed output scheme.

(c) of FIG. 12 illustrates the arrangement of the output areas when the output area 1210a corresponding to identification sign 1 is removed and a vertical length is set as the expansion priority direction in the space expander 173.

Since the direction along the vertical length is set as the expansion priority direction in the space expander 173, the output area 1230a corresponding to identification sign 2 is expanded to an output area 1230c corresponding to identification sign 2 that is expanded, by the output area 1210a corresponding to identification sign 1 that is removed.

When the output scheme of the webpage that is output through the output area 1230c corresponding to identification sign 2 that is expanded is changed by the output scheme changer 150, the change output device 170 outputs the webpage through the output area 1230c corresponding to identification sign 2 that is expanded, according to the changed output scheme.

FIG. 13 schematically illustrates a result of removing one output area from a web browser window outputting a combined webpage having a plurality of output areas according to an embodiment different from FIG. 12.

(a) of FIG. 13 illustrates a web browser window before an output area corresponding to identification sign 1 is removed from the web browser window including a plurality of output areas, in which a web browser window may include five output areas including an output area 1310a corresponding to identification sign 1, an output area 1330a corresponding to identification sign 3, and an output area 1350a corresponding to identification sign 4.

A unique identification sign is assigned to each output area included in the web browser window 1300a. This is to allow each output area to output a webpage corresponding to other webpage address, and when a user's input about the space removal button is received, to remove the output area including the space removal button that received the user's input and to identify an output area to be expanded.

(b) of FIG. 13 illustrates the arrangement of the output areas when the output area 1330a corresponding to identification sign 3 is removed and a horizontal length is set as the expansion priority direction in the space expander 173.

Since the direction along the horizontal length is set as the expansion priority direction in the space expander 173, the output area 1310a corresponding to identification sign 1 is expanded to an output area 1310b corresponding to identification sign 1 that is expanded, by the output area 1330a corresponding to identification sign 3 that is removed.

In this process, as the vertical length of the output area 1350a corresponding to identification sign 4 is partially reduced as the output area 1310b corresponding to identification sign 1 is removed. The process of reducing the vertical length of the output area 1350a corresponding to identification sign 4 is described in detail with reference to the flowchart of FIG. 14.

When the output scheme of the webpage that is output through the output area 1310b corresponding to identification sign 1 that is expanded is changed by the output scheme changer 150, the change output device 170 outputs the webpage through the output area 1310b corresponding to identification sign 1 that is expanded, through the changed output scheme.

(c) of FIG. 13 illustrates the arrangement of the output areas when the output area 1330a corresponding to identification sign 3 is removed and a vertical length is set as the expansion priority direction in the space expander 173.

Since the direction along the vertical length is set as the expansion priority direction in the space expander 173, the output area 1350a corresponding to identification sign 4 and an output area 1370a corresponding to identification sign 5 in (a) of FIG. 13 are respectively expanded to an output area 1350c corresponding to identification sign 4 that is expanded and an output area 1370c corresponding to identification sign 5 that is expanded, by the output area 1330a corresponding to identification sign 3 that is removed.

As described above, the space expander 173 identifies the output area to be expanded due to the removed output area, and expands the identified output area. Thus, when the output area 1330a corresponding to identification sign 3 is removed and the expansion priority direction is set to be the vertical length direction, the space expander 173 may recognize the output area 1350a corresponding to identification sign 4 and the output area 1370a corresponding to identification sign 5 to be output areas that are expandable.

When the output scheme of the webpage that is output through the output area 1350c corresponding to identification sign 4 that is expanded and the output scheme of the webpage that is output through the output area 1370c corresponding to identification sign 5 that is expanded are changed by the output scheme changer 150, the change output device 170 outputs the respective webpages according to the changed output schemes.

FIG. 14 is a flowchart showing a process of removing a particular output area from a web browser window outputting a combined webpage having a plurality of output areas.

For convenience of explanation, the block diagram of FIG. 1 is referred to.

First, the space remover inspects a user's input of a space removal button (S1410). When a user using a web browser window including a plurality of output areas wants to remove one output area, the user may press a space removal button included in an output area to be removed. The space remover may detect the user's pressing the space removal button, remove the output area including the space removal button on which pressing is detected, and transmit information about the identification sign, size, and position of the output area including the space removal button to the space expander.

The space expander determines for which of the output areas to be expanded a space obtained due to the removed output area is used (S1430).

In detail, the space expander may receive the identification sign of the removed output area from the space remover, and identify the identification sign of the output area to be expanded based on the expansion priority direction stored in the space expander.

The space expander identifies the size and position of the removed output area and calculates how large an expanded space of the output area to be expanded is (S1450).

When there are a plurality of output areas to be expanded in an expansion priority direction, a space obtained by dividing the size of the removed output area by the number of the output areas to be expanded is a space to be expanded.

For example, referring to FIG. 13, in (a) of FIG. 13, when the expansion priority direction is a vertical length direction, the output area 1350a corresponding to identification sign 4 and the output area 1370a corresponding to identification sign 5 are expanded as large as a space obtained by dividing the size of the removed output area into two (1350c and 1370c), as illustrated in (c) of FIG. 13.

In an example of operation S1450, the space expander determines whether the total size of the output space of a web browser window when the output area to be expanded is expanded is the same as the sum of the sizes of all output areas constituting a combined webpage, and if both values are not the same, searches an output area to be additionally expanded or reduced and calculates how large a space of a found output area is expanded or reduced.

In the present embodiment, when the total size of the output space of the web browser window is greater than the sum of the sizes of all output areas constituting the combined webpage, the space expander searches an output area to be additionally expanded. Furthermore, when the total size of the output space of the web browser window is less than the size of all output areas constituting the combined webpage, the space expander searches an output area to be further reduced.

The space expander may use whether the size of the output area may be changed in only one direction of the horizontal length direction and the vertical length direction as a reference for searching and determining an output area to be additionally expanded or reduced, to remove a remaining or lacking space in the entire output space after the output area to be expanded is expanded.

In other words, the space expander identifies the size and position for each identification sign, and determines an output area that may remove the remaining or lacking space in the entire output space when the length is changed in only one of the horizontal length direction and the vertical length direction, to be the output area to be expanded or reduced. The output area to be further expanded or reduced may be a plurality of output areas, and the output area may be expanded or reduced to be relatively small in inversely proportional to the number.

In the description of the present embodiment with reference to (a) and (b) of FIG. 12, first, the space remover detects the user's input of the space removal button (S1410). The space expander determines for expansion of which of the output areas the space obtained as the output area 1210a corresponding to identification sign 1 is removed (S1430). In (b) of FIG. 12, since the horizontal length direction is set to be the expansion priority direction, the output area 1250a corresponding to identification sign 3 is determined to be an output area to be expanded. When the output area 1250a corresponding to identification sign 3 is expanded with priority in the direction along the horizontal length, the space expander determines that the sum of the sizes of the output areas constituting the combined webpage is not the same as the total size of the output space of the web browser window.

When the output area 1250a corresponding to identification sign 3 is expanded with priority in the direction along the horizontal length, the space expander determines that the sum of the sizes of the output areas constituting the combined webpage is less than the total size of the output space of the web browser window, and searches an output area to be additionally expanded.

The space expander identifies the positions and sizes of the output areas other than the output area 1210a corresponding to identification sign 1 that is removed and the output area 1250a corresponding to identification sign 3 that is already expected to be expanded. The space expander determines the positions and sizes of the remaining space in the entire output space of the web browser window, and determines the output area 1230a corresponding to identification sign 2 that may remove the remaining space of the entire output space by being expanded in the vertical length direction, to be an output area to be additionally expanded.

Next, the space expander calculates how large the output area 1230a corresponding to identification sign 2 is expanded. The space expander determines the vertical length of the output area 1230b corresponding to identification sign 2 that is expanded by adding the vertical length of the remaining space in the entire output space of the web browser window to the vertical length of the output area 1230a corresponding to identification sign 2.

In other words, the space expander determines that the output area to be expanded is primarily the output area 1250a corresponding to identification sign 3 and secondarily the output area 1230a corresponding to identification sign 2, and determines information about the size of each of the output areas 1230a and 1250a that are expanded (S1450).

In the present embodiment, the process described with reference to (a) and (b) of FIG. 12 may be applied to (a) and (b) of FIG. 13 without change as follows.

Referring to (a) and (b) of FIG. 13, in the present embodiment, first, the space remover detects the user's input of the space removal button (S1410). The space expander determines for expansion of which of the output areas the space obtained as the output area 1330a corresponding to identification sign 3 is removed (S1430). In (b) of FIG. 13, since the horizontal length direction is set to be the expansion priority direction, the output area 1310a corresponding to identification sign 1 is determined to be an output area to be expanded. When the output area 1310a corresponding to identification sign 1 is expanded with priority in the direction along the horizontal length, the space expander determines that the sum of the sizes of the output areas constituting the combined webpage is not the same as the total size of the output space of the web browser window.

When the output area 1310a corresponding to identification sign 1 is expanded with priority in the direction along the horizontal length, the space expander determines that the sum of the sizes of the output areas constituting the combined webpage is greater than the total size of the output space of the web browser window, and searches an output area to be additionally reduced.

The space expander identifies the positions and sizes of the output areas other than the output area 1330a corresponding to identification sign 3 that is removed and the output area 1310a corresponding to identification sign 1 that is already expected to be expanded. The space expander determines the positions and sizes of the remaining space in the entire output space of the web browser window, and determines the output area 1350a corresponding to identification sign 4 and the output area 1370a corresponding to identification sign 5 that may remove the remaining space of the entire output space by being reduced in the vertical length direction, to be an output area to be additionally expanded.

Next, the space expander calculates how large the output area 1350a corresponding to identification sign 4 and the output area 1370a corresponding to identification sign 5 are reduced. The space expander equally subtracts the vertical length of the lacking space in the entire output space of the web browser window from the vertical length of each of the output area 1350a corresponding to identification sign 4 and the output area 1370a corresponding to identification sign 5.

In other words, the space expander determines that the output area to be primarily expanded is the output area 1310a corresponding to identification sign 1 and that the output area to be secondarily reduced is the output area 1350a corresponding to identification sign 4 and the output area 1370a corresponding to identification sign 5, and determines information about the size of each output area (S1450).

The space expander expands one output space selected from the output space adjacent to the output space removed according to the value calculated in the operation S1450, and transfers the information about the size and position of the output space that is expanded to the output scheme changer (S1470). Next, the output scheme changer changes the webpage output scheme about the expanded output area based on the received information and transfers a changed webpage output scheme to the change output device, and the change output device outputs the webpage in the output area expanded based on the received output scheme (S1490).

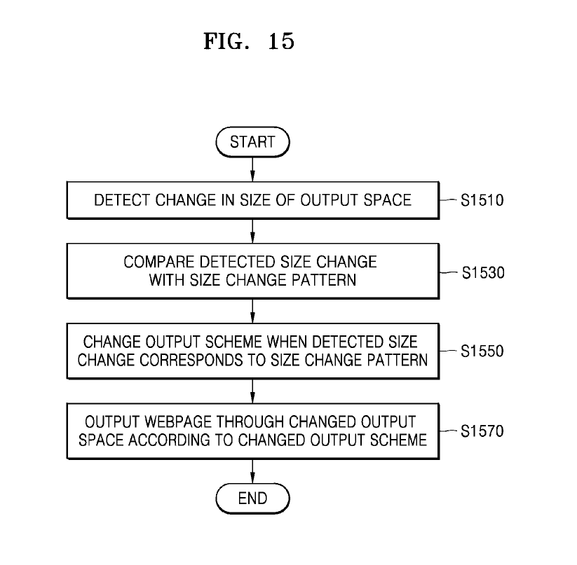

FIG. 15 is a flowchart showing a method of changing a webpage output scheme according to another embodiment.

The method of changing a webpage output scheme illustrated in the flowchart of FIG. 15 may be implemented by the apparatus 100 for changing a webpage output scheme illustrated in FIG. 1, and redundant descriptions therebetween are omitted.

The size change detector detects a change in the size of the output space outputting a webpage (S1510).

When the size change of the output space is detected, the size change detector may display, in the output space, an effective change point to change the output scheme of the webpage that is output through the output space. The effective change point may be a minimum change point to allow the webpage output scheme to be changed and output by the apparatus for changing a webpage output scheme according to the present inventive concept.

When the size change of the output space outputting a webpage is detected, the size change detector may transfers information about the size change to the pattern determiner. The information about the size change may signify information about how large and in which direction the output space outputting a webpage is expanded or reduced by the user's input.

The size change detector stores information about the effective change point corresponding to the minimum change point, and displays the effective change point in the output space whenever the user tries to change the size of the web browser window. Accordingly, the user may visually check a degree of the size change of the output space needed to change the webpage output scheme.

In some embodiments, the effective change point may be defined to be not only a minimum change point to enable the webpage output scheme to be changed and output, but also a recommended change point to enable the webpage output scheme to be most ideally changed and output.

Furthermore, the point where the effective change point is displayed may be a preset particular point. For example, the effective change point may be fixedly displayed at a location where the 100th pixel from the top of the output space is located. In such a method, regardless of the total size of the output space, the point where the effective change point is displayed is located at a location where the 100th pixel from the top of the output space is located.

Since the size change detector storing the information about the effective change point corresponding to the recommended change point displays the effective change point when detecting that the user tries to change the size of a web browser window, the user may easily change the size of the output space referring to the effective change point.

In some embodiments, even when the size change detector 110 detects the size change of the output space, the user may set such that the detected information about the size change is not transferred to the pattern determiner 130. In other words, the user may change the webpage output scheme according to the present inventive concept only when the user desires so.

When the size change detector detects the size change, the pattern determiner determines whether the size change corresponds to the previously stored size change pattern (S1530).

The size change pattern is information previously stored in the pattern determiner to be compared with the information about the size change of the output space that is transferred by the size change detector. The size change pattern stored in the pattern determiner may include at least one of size change direction, a size change degree, and a size change type. The size change direction may be a horizontal direction or a vertical direction, the size change degree may be a fixed constant or ratio, and the size change type may be either expansion or reduction.

At least one size change pattern is stored in the pattern determiner. The number of size change patterns stored in the pattern determiner may be increased or decreased by a user having a right to change the setting of the apparatus for changing a webpage output scheme according to the present inventive concept.

When the size of the output space of the web browser window is changed within a range previously stored in the size change pattern, the pattern determiner may determine that the size change corresponds to the previously stored size change pattern. The size change pattern stored in the pattern determiner may be set to have a sufficient allowable range to cope with user's various motions. After determining whether the size change by the user's input corresponds to the previously stored size change pattern, the pattern determiner transfers a result of the determination to the output scheme changer.

When receiving a result of the determination from the pattern determiner that the size change of the output space does not correspond to the previously stored size change pattern, the output scheme changer does not change the output scheme.

In some embodiments, when determining that the size change of the output space does not correspond to the previously stored size change pattern, the pattern determiner may not transfer the determination result to the output scheme changer and may not change the output scheme.

When the size change of the output space detected by the size detection unit corresponds to the previously stored size change pattern, the output scheme changer may change the output scheme to have the positions of constituent items constituting the webpage rearranged based on the changed size of the output space (S1550).

When the size change of the output space corresponds to the size change pattern, the output scheme changer calculates a size change ratio by comparing the changed size of the output space with the size of the output space before the change, and may change the output scheme of the webpage that is output through the output space changed according to the calculated size change ratio.

In detail, the output scheme changer, as the determination result of the pattern determiner, may change the webpage output scheme based on the size of the output space before changed by the user's input and the size of the output space after changed by user's input.

First, the output scheme changer may obtain information about each item constituting the webpage by analyzing the script of the webpage.

In detail, the output scheme changer may identify constituent items such as a banner, a motion picture, a still image, text, etc. output by being included in a webpage, from the script written in the web document, by opening the web document about the webpage that may be accessed by accessing a webpage address, and obtain information about each of the identified constituent items. The information about the constituent item may include information about a size such as a width or height of a constituent item.

After obtaining the information about each item constituting the webpage, the output scheme changer determines the item change ratio to change the size of each constituent item based on the changed size of the output space.

As an example in which the output scheme changer determines the item change ratio based on the changed size of the output space, the output scheme changer analyzes at which ratio the size of the output space before the change is changed to the size of the output space after the change and then determines the item change ratio based on the determined ratio. An example of the ratio determined by the output scheme changer may be the above-described size change ratio.

As another example in which the output scheme changer determines the item change ratio based on the changed size of the output space, when the size of the output space is changed, the output scheme changer determines a value corresponding to the changed size of the output space to be an item change ratio.

As another example in which the output scheme changer determines the item change ratio based on the changed size of the output space, the output scheme changer may determine the item change ratio based on the changed size of the output space and the entire length of the webpage.

Inequality 1 described above may be an example of an equation used when the output scheme changer determines the item change ratio based on the changed size of the output space and the entire length of the webpage.

The output scheme changer may determine a value of a reciprocal of a natural number most close to the size change ratio of the output space to be a ratio to change the size of each constituent item. This is already described above with the descriptions of Inequality 1 and FIG. 6.

The output scheme changer may determine the item change ratio based on the entire vertical length of the webpage and the changed vertical length of the output space. The output scheme changer may determine the item change ratio by selecting only the largest value from among values satisfying the correlation such as Inequality 1. The output scheme changer determines the item change ratio and the number of frames included in the changed output space through the correlation such as Inequality 1 in order to output the entire content included in the webpage to the changes output space.

The output scheme changer 150 determines the item change ratio to change the size of each constituent item based on the changed size of the output space, and then changes the size of each constituent item according to the determined item change ratio.

The size of the constituent item may signify at least one of the horizontal length and the vertical length of the constituent item. In other words, the constituent item may be changed in the horizontal length only, in the vertical length only, or in both the horizontal length and the vertical length, according to the item change ratio. There is at least one constituent item constituting the webpage, and each constituent item is changed according to the item change ratio in the same method.

When the size of the constituent item is changed, the output scheme changer rearranges the constituent item having a changed size in the changed output space.

First, the output scheme changer divides the changed output space into at least two or more frames based on the direction in which the size of the output space is changed and the item change ratio. Each frame may be defined to be a space including in the changed output space through which the constituent item having a changed size is output.

The number of frames included in the changed output space may be a reciprocal of the item change ratio. Since the item change ratio is expressed in the form of 1/n, where “n” is an integer greater than 1, the number of frames included in the changed output space may be 2, 3, or 4. The output scheme changer sequentially arranges the constituent items having changed sizes in the at least two frames. The output scheme changer arranges a constituent item having a changed size in a first frame in the changed output space. The first frame is a frame located at the leftmost or the top of a plurality of frames, which may be a frame that, in general, the user first see when viewing the content of the webpage in the changed output space. For example, when the size change of the output space is a reduction in the vertical length, the position of the first frame may be the frame located at the leftmost side in the changed output space, which is schematically described above in FIGS. 3 to 6. When no remaining space to arrange the constituent items therein is left any longer as the constituent items having changed sizes are arranged in the first frame, the output scheme changer repeats arrangement of the constituent item having a changed size in a frame next to the first frame, and thus all constituent items constituting the webpage may be output in the respective frames of the changed output space.

As an example in which the output scheme changer determines that no remaining space is left in the frame, the output scheme changer may calculate the vertical length of the webpage that may be output from the frame, and may determine that there is no remaining space left in the frame, based on a result of the calculation.

As another example in which the output scheme changer determines that no remaining space is left in the frame, the output scheme changer may receive information indicating that no constituent item may be arranged in the frame, and may determine that no remaining space is left in the frame, based on the received information. The output scheme changer may determine that the remaining space to arrange the constituent item is insufficient in the frame, based on the information indicating that no constituent item may be arranged in a current frame, and may arrange the constituent item having a changed size in a next frame.

Alternatively, the output scheme changer may determine that it is inappropriate to divide and arrange a constituent item that is a still image or a motion picture having a relatively large size, across two frames, and may arrange the constituent item in a next frame having a sufficient space.

Finally, the output scheme changer may define a new output scheme based on the constituent item determined through the previous operations, a reduction ratio of the constituent item, and information needed to rearrange a reduced constituent item in the changed output space, and may change the existing output scheme to a newly defined output scheme.

When a degree of changing the size of a web browser window by the user is not much or the length of the webpage corresponds to a specific length, space may be left after the constituent item having a changed size is arranged in each frame.

In some embodiments, when the size change of the output space is a reduction in the vertical length of the output space, the output scheme changer may calculate the expanded output space in which the horizontal length of the changed output space is additionally expanded according to the size change ratio. The calculated expanded output space may be an output space through which the webpage is output by the change output device. As described above, to calculate the expanded output space, the output scheme changer may additionally receive information about the horizontal length of the display of a user's terminal.

The change output device outputs the webpage through the changed output space according to the changed output scheme by the output scheme changer (S1570).

In some embodiments, the change output device may rearrange and output the constituent items of the webpage in the expanded output space calculated by the output scheme changer, according to the changed output scheme.

In some embodiments, the change output device may divide the changed output space into at least two individual output spaces, and each constituent item rearranged according to the output scheme changed by the output scheme changer may be output in individual output space. The individual output space may be defined to be an independent output space assigned with the unique identification sign. Furthermore, the individual output space may include the space removal button that may be selected by the user.

When the space removal button is selected by the user, the change output device may remove the individual output space including the selected space removal button, and expand the individual output space adjacent to the removed individual output space as large as a space calculated duet to the removed individual output space.

In the method of changing a webpage output scheme according to another embodiment of the present inventive concept, the output space may be one of a plurality of output areas included in the combined webpage. Each of the output areas may signify an area through which an independent webpage is output, and the size of each output area may be changed.

In the present embodiment, the combined webpage is a webpage that is output when the user inputs a webpage address to output the combined webpage in an address section of a web browser window, and signifies a webpage having a plurality of output areas, in each of which an independent webpage is output. In other words, in the present embodiment, the output area is characteristically identical to the output space in that it is an area in which a webpage having a changeable size may be output. When the size of the output area is changed, the output scheme of the webpage output in the output area may be changed.

In the apparatus and method for changing a webpage output scheme according to the present inventive concept, since the user may view the content provided by a webpage at a glance without performing separate scroll operations by only adjusting the size of a web browser window, the user may conveniently surf the web while performing other work, with improved visual effects.

The present inventive concept may be used for development of dedicated web browsers to implement the method of changing a webpage output scheme, or may be implemented in the form of a plug-in or an extended program for the existing web browsers such as Explorer, Firefox, or Chrome, thereby improving work efficiency of a user performing work through a network.

The embodiments of the present inventive concept can be written as computer programs and can be implemented in general-use digital computers that execute the programs using a computer readable recording medium. Examples of the computer-readable recording medium include magnetic media, e.g., hard disks, floppy disks, and magnetic tapes, optical media, e.g., compact disc read only memories (CD-ROMs) and digital versatile disks (DVDs), magneto-optical media, e.g., floptical disks, and hardware device configured to store and execute program commands, for example, programming modules, e.g., read only memories (ROMs), random access memories (RAMs), flash memories. Furthermore, the medium may include intangible medium implemented to be capable of transmitting on a network. For example, the medium may be implemented in the form of software or application so as to be transmitted and distributed via a network.

The computer program may be specially designed and configured for the present inventive concept or may be well-known to one skilled in the art of computer software, to be usable. An example of a computer program may include not only machine codes created by a compiler but also high-level language code executable by a computer using an interpreter.

The particular implementations shown and described herein are illustrative examples of the inventive concept and are not intended to otherwise limit the scope of the inventive concept in any way. For the sake of brevity, conventional electronics, control systems, software development and other functional aspects of the systems may not be described in detail. Furthermore, the connecting lines, or connectors shown in the various figures presented are intended to represent functional relationships and/or physical or logical couplings between the various elements. It should be noted that many alternative or additional functional relationships, physical connections or logical connections may be present in a practical device. Moreover, no item or component is essential to the practice of the inventive concept unless the element is specifically described as “essential” or “critical.”

The use of the terms “a” and “an” and “the” and similar referents in the context of describing the inventive concept (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the steps of all methods described herein can be performed in any suitable order unless otherwise indicated herein or otherwise clearly contradicted by context. The present inventive concept is not limited to the described order of the steps. The use of any and all examples, or language (e.g., “such as”) provided herein, is intended merely to better illuminate the inventive concept and does not pose a limitation on the scope of the inventive concept unless otherwise claimed. Numerous modifications and adaptations will be readily apparent to one of ordinary skill in the art without departing from the spirit and scope of the present inventive concept.

### INDUSTRIAL APPLICABILITY

The above-described embodiments of the present inventive concept may be applied to implement web browser software or a plug-in included in the web browser which enables a user to Internet surfing through various wired or wireless communications.

1. An apparatus for changing a webpage output scheme, comprising:
a size change detector detecting a size change of an output space outputting a webpage;
a pattern determiner, when the size change is detected, determining whether the size change corresponds to a previously stored size change pattern;
an output scheme changer, when the size change corresponds to the size change pattern, changing an output scheme to rearrange a position of a constituent item constituting the webpage based on a changed size of the output space; and
a change output device outputting the webpage through a changed output space according to a changed output scheme.

2. The apparatus of claim 1, wherein the output scheme changer calculates a size change ratio by comparing the changed size of the output space with the size of the output space before a change, when the size change corresponds to the size change pattern, and changes the output scheme of the webpage that is output through the changed output space according to the size change ratio.

3. The apparatus of claim 2, wherein the size change is a reduction in a vertical length, and
when the size change corresponds to the size change pattern, the output scheme changer reduces horizontal and vertical lengths of the constituent item based on the changed size of the output space and the size change ratio, and changes the output scheme to rearrange a position of a reduced constituent item.

4. The apparatus of claim 2, wherein the size change is a reduction in a vertical length,
the output scheme changer calculates an expanded output space by additionally expanding the horizontal length of the changed output space according to the size change ratio, and
the change output device outputs the webpage through the expanded output space according to the changed output scheme.

5. The apparatus of claim 1, wherein the change output device divides the changed output space into at least two individual output spaces, and
each constituent item rearranged by the output scheme changed by the output scheme changer is output through the individual output space.

6. The apparatus of claim 5, wherein the individual output space comprises a space removal button that receives a user's selection, and
the change output device comprises:
a space remover removing the individual output space including the space removal button, when the space removal button is selected; and
a space expander expanding an individual output space adjacent to the removed individual output space as large as a space calculated due to the removed individual output space.

7. The apparatus of claim 1, wherein the size change pattern comprises a reduction in the horizontal length or vertical length over a certain ratio or more among the horizontal length or vertical length of the output space.

8. The apparatus of claim 1, wherein, when the size change of the output space is detected, the size change detector displays in the output space an effective change point to change the output scheme of the webpage that is output through the output space.

9. The apparatus of claim 1, wherein the output space is one of a plurality of output areas included in a combined webpage, and
an independent webpage is output through each of the plurality of output areas, and the size of the output area is changeable.

10. A method of changing a webpage output scheme, the method comprising:
a size change detection operation of sensing a size change of an output space outputting a webpage;
a pattern determination operation of, when the size change is detected, determining whether the size change corresponds to a previously stored size change pattern;
an output scheme change operation of, when the size change corresponds to the size change pattern, changing an output scheme to rearrange a position of a constituent item constituting the webpage based on a changed size of the output space; and
a change output operation of outputting the webpage through a changed output space according to a changed output scheme.

11. The method of claim 10, wherein, in the output scheme change operation, when the size change corresponds to the size change pattern, a size change ratio is calculated by comparing the changed size of the output space with the size of the output space before a change, and
the output scheme of the webpage that is output through the changed output space is changed according to the size change ratio.

12. The method of claim 11, wherein the size change is a reduction in a vertical length, and
in the output scheme change operation, when the size change corresponds to the size change pattern, horizontal and vertical lengths of the constituent item are reduced based on the changed size of the output space and the size change ratio, and the output scheme to rearrange a position of a reduced constituent item is changed.

13. The method of claim 11, wherein the size change is a reduction in a vertical length,
in the output scheme change operation, an expanded output space by additionally expanding the horizontal length of the changed output space according to the size change ratio is calculated, and
in the change output operation, the webpage is output through the expanded output space according to the changed output scheme.

14. The method of claim 10, wherein, in the change output operation, the changed output space is divided into at least two individual output spaces, and
each constituent item rearranged by the output scheme changed in the output scheme change operation is output through the individual output space.

15. The method of claim 14, wherein the individual output space comprises a space removal button that receives a user's selection, and
the change output operation comprises:
a space removal operation of removing the individual output space including the space removal button, when the space removal button is selected; and
a space expanding operation of expanding an individual output space adjacent to the removed individual output space as large as a space calculated due to the removed individual output space.

16. The method of claim 10, wherein the size change pattern comprises a reduction in the horizontal length or vertical length over a certain ratio or more among the horizontal length or vertical length of the output space.

17. The method of claim 10, wherein, in the size change sensing operation, when the size change of the output space is detected, an effective change point to change the output scheme of the webpage that is output through the output space is displayed in the output space.

18. The method of claim 10, wherein the output space is one of a plurality of output areas included in a combined webpage, and
an independent webpage is output through each of the plurality of output areas, and the size of the output area is changeable.

19. A non-transitory computer readable recording medium having recorded thereon a program, which when executed by a computer, performs the method defined in claim 10.
